(19) United States
(12) Patent Application Publication
(10) Pub. No.: US 2024/0179218 A1
(43) Pub. Date: May 30, 2024

(54) DETERMINING NETWORK-SPECIFIC USER BEHAVIOR AND INTENT USING SELF-SUPERVISED LEARNING

(71) Applicant: Cisco Technology, Inc., San Jose, CA (US)

(72) Inventors: Doosan Jung, Lakewood, CO (US); Qihong Shao, Clyde Hill, WA (US); Miriam Wagner Valladolid, San Francisco, CA (US)

(21) Appl. No.: 18/072,267

(22) Filed: Nov. 30, 2022

(51) Int. Cl. H04L 67/50; G06N 20/00

(52) U.S. Cl. CPC H04L 67/535; G06N 20/00

(57) ABSTRACT

Methods are provided for generating recommendations related to a network domain by performing self-supervised machine learning using masked modeling of input data related to user interactions with the network domain and/or network related information. Specifically, a computing device obtains input data including one or more of network information indicative of a plurality of network devices in a network domain and user behavior information indicative of one or more user interactions with the network domain. The computing device performs a self-supervised machine learning using mask modeling of a plurality of elements that represent the input data, to determine contextual meaning of the input data and generating at least one actionable task related to the network domain based on the contextual meaning of the input data. The computing device further provides the at least one actionable task for performing one or more actions associated with the network domain.

### TECHNICAL FIELD

The present disclosure generally relates to computer networks and systems.

### BACKGROUND

Enterprise networks include many assets and involve various enterprise service functions for equipment and software. Enterprise networks are often managed by a team of information technology (IT) specialists. This is particularly the case for enterprises that have large networks or systems of numerous instances and types of equipment and software. Tracking performance, troubleshooting, and integrating new technology and/or updates for networking or equipment and software in large enterprise networks is time consuming and often requires support and guidance from providers or third-party entities. Understanding behavior and intent of the IT specialist is important to providing proper support and guidance.

### BRIEF DESCRIPTION OF THE DRAWINGS

FIG. 1 is a block diagram of a system that includes a network domain self-supervised learning service that interacts with an enterprise service cloud portal and network/computing equipment and software residing at various enterprise sites of an enterprise network domain, according to an example embodiment.

FIG. 2 is a block diagram illustrating components of a network domain self-supervised learning service, according to an example embodiment.

FIG. 3 is a diagram illustrating an event embedding process in which user behavior information is embedded to form an event embedding structure, according to an example embodiment.

FIG. 4A is a diagram illustrating generating an event embedding which represents contextual meaning of a respective event, according to an example embodiment.

FIG. 4B is a diagram illustrating generating a sequence embedding which represents contextual meaning of the sequence, according to an example embodiment.

FIG. 4C is a diagram illustrating generating a position embedding in which a position of an event within a sequence is encoded, according to an example embodiment.

FIG. 5 is a diagram illustrating an embedding process in which user interactions with the cloud portal are encoded into a network management event embedding structure, according to an example embodiment.

FIG. 6A is a diagram illustrating a group embedding process in which various event sequences are classified into one or more groups, according to an example embodiment.

FIG. 6B is a diagram illustrating an attribute discovery process in which one or more attributes for grouping event sequences are determined, according to an example embodiment.

FIG. 6C is a block diagram illustrating an event embedding structure in which grouping information is encoded therein, according to an example embodiment.

FIG. 7 is a diagram illustrating performing masked event modeling of an event embedding structure to determine contextual meaning of events, according to an example embodiment.

FIG. 8A is a view illustrating an adjacency label assigned to event sequences determined to be related based on performing adjacent sequence prediction (ASP) of self-supervised machine learning, according to an example embodiment.

FIG. 8B is a view illustrating not adjacent label being assigned to event sequences determined to be unrelated based on performing the ASP of self-supervised machine learning, according to an example embodiment.

FIG. 9 is a diagram illustrating performing self-supervised machine learning of an event embedding structure to determine contextual meanings of events and event sequences, according to an example embodiment.

FIGS. 10A and 10B are views illustrating contextual meaning of events and contextual meaning of event sequences, respectively, according to one or more example embodiments.

FIG. 11 is a diagram illustrating a network embedding process in which network information is embedded to form a network embedding structure, according to an example embodiment.

FIG. 12 is a diagram illustrating a topology embedding process in which device and site connection information is encoded, according to an example embodiment.

FIG. 13 is a diagram illustrating performing self-supervised machine learning of a network embedding structure to determine contextual meaning of the network domain, according to an example embodiment.

FIGS. 14A and 14B are views illustrating contextual meaning of devices and contextual meaning of network sites, respectively, according to one or more example embodiments.

FIG. 15A is a diagram illustrating a device embedding space with contextual meaning of user behavior encoded therein, according to an example embodiment.

FIG. 15B is a diagram illustrating another device embedding space with contextual meaning of user behavior encoded therein, according to another example embodiment.

FIG. 16 is a view illustrating a user interface in which a shortcut for executing one or more actions that relate to a configuration or management of the network domain, is generated based on contextual meaning of the input data, according to an example embodiment.

FIG. 17 is a view illustrating a user interface of a cloud portal in which virtual assistance provides in-time support for executing user-intended actionable tasks for configuring or managing the network domain, according to an example embodiment.

FIG. 18 is a view illustrating another user interface of the cloud portal in which virtual assistance provides an efficient path for performing at least one actionable task, according to an example embodiment.

FIG. 19 is a view illustrating another user interface of the cloud portal that provides guided support for performing at least one actionable task, according to an example embodiment.

FIG. 20 is a flowchart illustrating a method of providing at least one actionable task for performing one or more actions associated with the network domain based on self-supervised machine learning, according to an example embodiment.

FIG. 21 is a hardware block diagram of a computing device that may perform functions associated with any combination of operations in connection with the techniques depicted and described in FIGS. 1-20, according to various example embodiments.

### DETAILED DESCRIPTION

### Overview

Techniques presented herein provide a task recommendation system that generates recommendations or insights related to a network domain by performing self-supervised machine learning using mask modeling of input data related to user interactions with the network domain and/or network related information.

In one form, a computing device obtains input data including one or more of network information indicative of a plurality of network devices in a network domain and user behavior information indicative of one or more user interactions with the network domain. The computing device performs a self-supervised machine learning using mask modeling of a plurality of elements that represent the input data, to determine contextual meaning of the input data. The computing device further generates at least one actionable task related to the network domain based on the contextual meaning of the input data and provides the at least one actionable task for performing one or more actions associated with the network domain.

### Example Embodiments

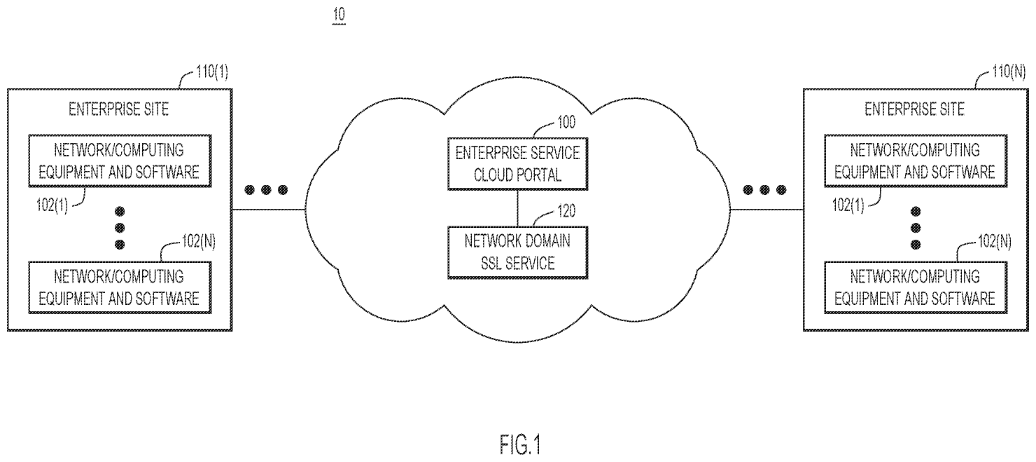

FIG. 1 is a block diagram of a system 10 that includes a network domain self-supervised learning service 120 that interacts with an enterprise service cloud portal (cloud portal) 100 and network/computing equipment and software 102(1)-102(N) residing at various enterprise sites 110(1)-110(N), or in cloud deployments of an enterprise, according to an example embodiment.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

The system 10 is one example of a network domain. The system 10 may involve multiple enterprise networks. The network/computing equipment and software 102(1)-102(N) are resources or assets of an enterprise (the terms “assets” and “resources” are used interchangeably herein). The network/computing equipment and software 102(1)-102(N) may include any type of network devices or network nodes such as controllers, access points, gateways, switches, routers, hubs, bridges, gateways, modems, firewalls, intrusion protection devices/software, repeaters, servers, and so on. The network/computing equipment and software 102(1)-102(N) may further include endpoint or user devices such as a personal computer, laptop, tablet, and so on. The network/computing equipment and software 102(1)-102(N) may include virtual nodes such as virtual machines, containers, point of delivery (POD), and software such as system software (operating systems), firmware, security software such as firewalls, and other software products. The network/computing equipment and software 102(1)-102(N) may be in a form of software products that reside in an enterprise network and/or in one or more cloud(s). Associated with the network/computing equipment and software 102(1)-102(N) is configuration data representing various configurations, such as enabled and disabled features. The network/computing equipment and software 102(1)-102(N), located at the enterprise sites 110(1)-110(N), represent information technology (IT) environment of an enterprise.

The enterprise sites 110(1)-110(N) may be physical locations such as one or more data centers, facilities, or buildings located across geographic areas that designated to host the network/computing equipment and software 102(1)-102(N). The enterprise sites 110(1)-110(N) may further include one or more virtual data centers, which are a pool or a collection of cloud-based infrastructure resources specifically designed for enterprise needs, and/or for cloud-based service provider needs.

The network/computing equipment and software 102(1)-102(N) may send to the cloud portal 100, via telemetry techniques, data about their operational status and configurations so that the cloud portal 100 is continuously updated about the operational status, configurations, software versions, etc. of each instance of the network/computing equipment and software 102(1)-102(N) of an enterprise.

The cloud portal 100 is driven by human and digital intelligence that serves as a one-stop destination for equipment and software of an enterprise to access insights and expertise when needed and specific to a particular stage of an adoption lifecycle. Examples of capabilities include assets and coverage, cases (errors or issues to troubleshoot), automation workbench, insights with respect to various stages of an adoption lifecycle and action plans to progress to the next stage, etc. The cloud portal 100 helps the enterprise network technologies to progress along an adoption lifecycle based on adoption telemetry and enabled through contextual learning, support content, expert resources, and analytics and insights embedded in context of the enterprise's current/future guided adoption tasks.

A network technology is a computing-based service or a solution that solves an enterprise network or a computing problem or addresses a particular enterprise computing need. The network technology may be offered by a service provider to address aspects of information technology (IT). Some non-limiting examples of a network technology include access policies, security and firewall protection services, software image management, endpoint or user device protection, network segmentation and configuration, software defined network (SDN) management, data storage services, data backup services, data restoration services, voice over internet (VOIP) services, managing traffic flows, analytics services, etc. Some network technology solutions apply to virtual technologies or resources provided in a cloud or one or more data centers. The network technology solution implements a particular enterprise outcome and is often deployed on one or more of the network/computing equipment and software 102(1)-102(N).

An adoption of network technology solution refers to enterprise's uptake and utilization of a network technology for achieving a desired outcome. A journey refers to end-to-end activities performed by an enterprise when adopting a network technology including tasks they perform and defined stages to progress. An adoption lifecycle refers to a step-by-step guidance along the adoption journey to accelerate the speed to value of a network technology. The adoption lifecycle may encompass the end-to-end journey stages of: need, evaluate, select, align, purchase, onboard, implement, use, engage, adopt, optimize, recommend, advocate, accelerate, upgrade, renew, etc.

As noted above, various IT specialists interact with the cloud portal 100 to manage equipment and software of the enterprise. Proper guidance, support, and other insights to help the user manage equipment and software of the enterprise via the cloud portal 100 are important. To provide proper guidance and/or for navigating the cloud portal 100, the network domain self-supervised learning (SSL) service 120 applies self-supervised learning (SSL) to user data and network information to understand or learn network-specific user behavior and intention(s) of the user. The network domain SSL service 120 analyzes click-through stream data indicative of user interactions with the network domain and/or network information, using SSL to generate user-specific downstream insights, recommendations, and/or actionable tasks. A recommendation includes one or more actionable tasks to be performed for configuring or managing the network domain. Each task includes one or more operations/actions. Recommendations are specifically tailored to the user's intent and the enterprise network.

For example, the network domain SSL service 120 may generate one or more shortcuts for executing one or more actions that relate to a configuration or management of the network domain (a link to an area where the next predicted action is to be performed). As another example, the network domain SSL service 120 may generate guided support for performing an actionable task by sequentially providing or executing a next action in the task (in-time and step by step support for the most efficient path to perform the actionable task). In one example, at least some of the actions may be performed by the network domain SSL service 120 itself or by the network domain SSL service 120 and the cloud portal 100 such as changing a configuration of a particular asset, updating software asset to a newer version, etc. The user is then notified that these automated actions were performed. As yet another example, the network domain SSL service 120 may generate recommendations for performing the same actions to similar devices in the network domain and/or for performing same actions as performed by other users with similar network domain, enterprise role, etc. (recommend installing the same security patch for a first network/computing equipment and software 102(1) that was installed on a second network/computing equipment 102(N), where the first network/computing equipment and software 102(1) and the second network/computing equipment and software 102(N) are similarly functioning and configured network devices).

While one or more example embodiments describe recommendations, insights, and/or actionable tasks (these terms are used interchangeably herein) with respect to the cloud portal 100, this is just an example. Actionable tasks may involve other services and/or systems. For example, actionable tasks may include a shortcut to a newer version of software available for downloading at an external website or a direct connection to an enterprise asset (network device) that needs to be reconfigured, etc. In other words, actionable tasks may or may not involve the cloud portal 100. In one example embodiment, actionable tasks may include a first action that involves a network management platform for a first enterprise site 110(1) and a second action that involves a network controller of the network domain, and a third action that involves a direct connection to one of the network/computing equipment and software 102(1)-(N) at a second enterprise site 110(N). Actionable tasks may include actions that are performed in multiple management platforms and the like.

Many challenges in providing services for a network domain stem from not understanding users' behavior, their intentions, and the network assets (network devices) that the users interact with. In the network domain, understanding user's behavior and intentions results in providing meaningful actionable tasks. The techniques provided herein gathering information about the network domain and observe user interactions related to the network domain and analyze this data using SSL to improve services and/or generate meaningful actionable tasks and/or recommendations. The techniques provided herein may improve products and services being offered to the users because the techniques determine how users utilize various network related products and services. They may further improve user's satisfaction based on guided support such as providing shortest path to complete the actionable task. Understanding user behavior and intentions in a network domain results in meaningful and useful actionable tasks.

For example, when users are browsing their network devices e.g., logging into the cloud portal 100, checking different devices' status, trying to fix a specific security issue, they may encounter some technical challenges and may be unable to progress with their task. The network domain SSL service 120 uses the user's real-time behavior sequence such as (1) the devices clicked on, (2) user's behavior of checking the “security issues” area, (3) discovering a critical security issue therein. Based on user intention modeling, the network domain SSL service 120 determines user's intention and provides in-time support and hints to help progress the user with the task e.g., a shortcut to a security update.

Understanding users' intention and behavior and providing actionable, relevant tasks may increase user stickiness, satisfaction, and simplifies even the more challenging tasks. Additionally, by understanding users' behavior, the service quality may be evaluated and improved. Further, users may be overwhelmed by the high number of capabilities available in a system such as the cloud portal 100 and users may become lost or confused. Increasing personalization levels, reducing the number of clicks to perform a specific task, and providing guidance to navigate through common tasks improves user friendliness of the system.

Understanding user's behavior and intentions in a network domain has unique challenges not encountered with other environments such as e-commerce or web searching. For example, the network domain SSL service 120 needs to understand network specific features such as network topology, security issues, device role, compatibility, etc. As another example, there are no labels or basics for network specific user behavior such as how users interact with their network devices, user's intention, etc. The network domain SSL service 120 applies machine learning to exploit various labels and sets learning objectives to generate supervision signals from data itself. The network domain SSL service 120 generates network-specific user behavior modeling based on SSL, using which actionable tasks are generated address specific user needs.

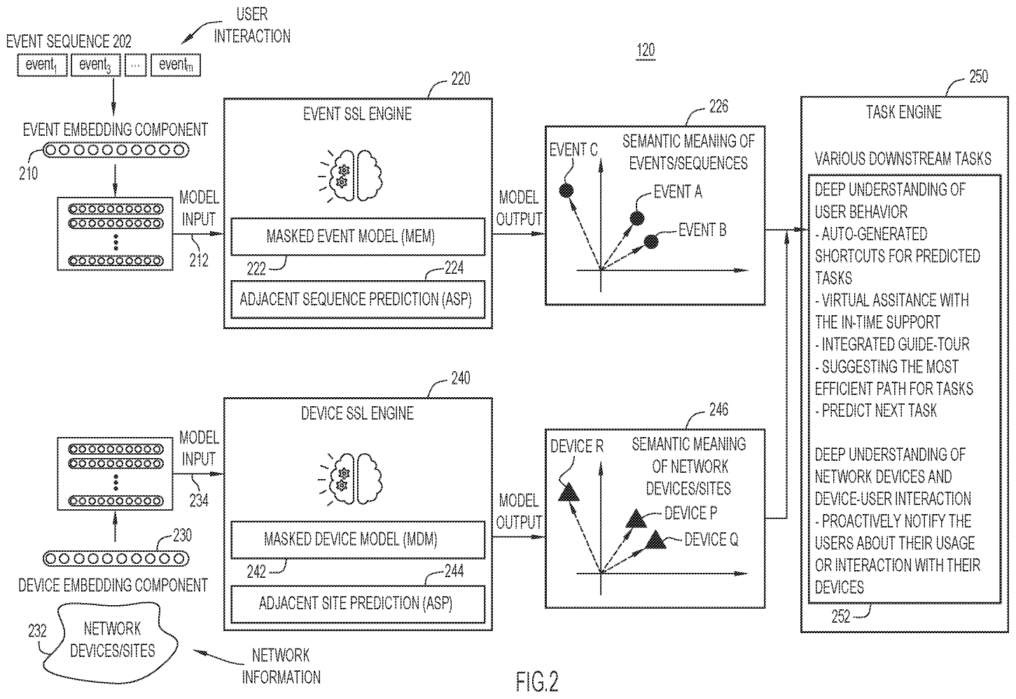

With continued reference to FIG. 1, FIG. 2 is a block diagram illustrating components of the network domain SSL service 120, according to an example embodiment. The network domain SSL service 120 includes an event embedding component 210, an event SSL engine 220, a device embedding component 230, a device SSL engine 240, and a task engine 250.

Natural language processing enables obtaining contextual, semantic meaning of words, sentences (relationship between words in a word sequence), paragraphs, language, etc. The network domain SSL service 120 obtains contextual or semantic meaning of events based on SSL. Similar to the natural language processing, a learned representation of an event captures the semantic and structural (contextual) meaning of the event.

The event embedding component 210 obtains user behavior information such as user interactions with a network device, the cloud portal 100, and/or other system or application in a network domain. User interactions are indicative of one or more actions performed by the user with respect to one or more components of the network domain. For example, a user action may include clicking on a particular function (e.g., an asset management page within the cloud portal 100). User interactions are a data source of user behavior and are captured in a form of click-through stream data.

The click-through stream data includes event sequences such as an event sequence 202. Each event sequence 202 includes multiple events (e.g., events₁, event₃, . . . eventₘ). Similar to a word in a natural language processing, an event represents an interaction or an action via an interface with a network device, a system, a network platform, the cloud portal 100, etc. For example, an event is a user click, a cursor movement, typing an alphanumeric character using a keyboard, a voice command, a body movement, a tactile action (touching the screen). An event is an operation performed by a user. An event sequence 202 is a set of related operations performed by a user within a predetermined or pre-defined time interval e.g., one to five seconds, one minute, etc. An event sequence 202 may define a particular function or task performed by a user e.g., upgrading software on a network device, rebooting a network device, configuring a network device, etc.

The event embedding component 210 embeds the input data (the event sequence 202) to generate event vectors and/or sequence vectors. That is, the event embedding component 210 processes the click-through stream data and generates an event embedding structure (model input 212), which includes one or more event sequences in a form of event vectors.

The event SSL engine 220 iteratively trains the event embedding structure (the model input 212) by replacing an event or an event sequence (an element) in the event embedding structure with a masked token to determine the contextual meaning of a user behavior defined by this event or event sequence. The event SSL engine 220 includes a masked even model (MEM) 222 and an adjacent sequence prediction 224.

The MEM 222 masks an event in the model input 212 with a token and then predicts which event is masked. That is, the MEM 222 hides a certain element in the event sequence 202 to determine or predict the missing/hidden event. By iteratively training the event embedding structure and masking various elements therein, the MEM 222 determines with high probability a specific masked event (e.g., last event in the event sequence 202 is “eventₘ” based on the event sequence 202 including event₁, event₃, . . . ).

The adjacent sequence prediction 224 determines the contextual, semantic meaning of event sequences. For example, if the event sequence 202 is a software upgrade task (e.g., upgrading software on a network device), what is the probability of the next event sequence is a rebooting task (e.g., restarting the network device). The adjacent sequence prediction 224 analyzes relationships among various event sequences to determine contextual and/or semantic meaning of these event sequences. The adjacent sequence prediction 224 determines a relationship between various user interactions and/or event sequences, thereby learning user's network-specific behavior and user intent.

The event SSL engine 220 generates a model output 226. The model output 226 is indicative of semantic or contextual meaning of events and/or event sequences in a form of event vectors and/or event sequence vectors. The event SSL engine 220 iteratively updates or improves the model output 226 with semantic or contextual meanings of the events and event sequences. The model output 226 is provided to the task engine 250 for generating various actionable tasks 252.

The device embedding component 230 obtains network information 232 indicative of the network devices and enterprise sites in the network domain. The network information 232 includes characteristics of the network/computing equipment and software 102(1)-102(N) of FIG. 1 such as a network device type, a device model, version, components (number of ports), a device product family type, role of the device in the network domain, etc. The network information 232 may further include characteristics of various enterprise sites 110(1)-110(N) of FIG. 1 such as geographic location, type and number of various devices, an enterprise type and size. The network information 232 may further include attributes of the network domain such as operational states, updates and configuration related data, faults, errors, and/or enterprise network domain related data such as purchase contracts, service contracts, warranty service agreements, license agreements and other asset information i.e., data about network/computing equipment and software 102(1)-102(N), at various enterprise sites 110(1)-110(N)). These are just some non-limiting examples of the network information 232. Type and quantity of the network information 232 may vary depending on a particular deployment of the network domain and/or use case scenario.

The device embedding component 230 embeds the network information 232 including connection of various network devices to generate a network embedding structure. The network embedding structure includes topology of the network domain defined by embedding connections among various network devices in the network domain. The network embedding structure may be in a form of multiple vectors.

The network embedding structure serves as a model input 234 to the device SSL engine 240. The device SSL engine 240 iteratively trains the network embedding structure (the model input 234) by replacing a network device and/or a network site (element) in the network embedding structure with a masked token to determine the contextual meaning of the network device and/or network site such as a device type, a device role in the network domain, device function, device product family type, etc. The device SSL engine 240 includes a masked device model (MDM) 242 and an adjacent site prediction 244.

The MDM 242 masks a device in the model input 234 (i.e., the device embedding structure) with a masked token and then predicts which device is hidden/masked. By iteratively training the device embedding structure and masking various elements therein, the MDM 242 determines with high probability contextual meaning of the masked device e.g., the network device must be a router connected to a device A and a device B.

The adjacent site prediction 244 determines the contextual, semantic meaning of enterprise sites and relationships between various enterprise sites. For example, a first enterprise site is the control center (main office) and second and third enterprise sites are remote local offices. As another example, the first enterprise site is controlled by an enterprise A and the second and third enterprise sites are controlled by an enterprise B. The adjacent site prediction 244 analyzes relationships among various enterprise sites in the network domain to determine contextual and/or semantic meaning of including the topology of the network domain.

The device SSL engine 240 generates a model output 246. The model output 246 is indicative of semantic or contextual meaning of network devices and/or enterprise sites in the network domain in a form of device vectors and/or enterprise site vectors. The event SSL engine 220 iteratively updates or improves the model output 246 by learning semantic or contextual meaning of network devices (e.g., device type, device role, device function(s), device components, device connections, and/or device product family), enterprise sites (e.g., controlled by which enterprise, size, number and types of devices, etc.), and/or relationships between entities and hierarchical structures in the network domain. The model output 246 is provided to the task engine 250 for generating various actionable tasks 252.

The task engine 250 obtains the model output 226 indicative of the contextual meaning of user interactions with the network domain and the model output 246 indicative of the contextual meaning of network devices and enterprise sites in the network domain. Using the model output 226 and the model output 246, the task engine 250 determines behavioral similarities between user interactions and device similarities between various network devices. The task engine 250 generates various actionable tasks 252 (downstream tasks). The actionable tasks may include a first action for a similar device in the network domain. For example, if a software upgrade A was performed for a device P, the same software upgrade A may be performed (or recommended) for a similar device Q. Further, various actionable tasks 252 may include recommending a similar action to the action already performed. As an example, based on performing a software upgrade, reboot (or recommend) to reboot the upgraded network device.

An actionable task includes one or more actions or operations performed by a user within a predetermined or pre-defined time interval e.g., one to five seconds, one minute, etc. An action involves one or more clicks or manipulations of a component in system(s) such as the cloud portal 100. In one example, the actionable task may be an automated task that is performed by the network domain SSL service 120 itself (or the network domain SSL service 120 in connection with the cloud portal 100, or directly with the network domain) such as changing a configuration of an asset in the network domain (upgrade software, change connection port of a network device, etc.). In this case, a user notification is generated indicating the progress or completion of the automated task.

Various actionable tasks 252 may include generating contextual information (support material or resources) from a technical assistance center (TAC) service requests (SRs) that is specific to the predicted next action in an actionable task. The actionable tasks 252 may further include generating shortcuts to product collateral such as instruction manuals and user manuals of the network devices involved in the predicted next action. Providing technical sites, learning and training materials, security notices, intellectual capital (IC) generated based on artificial intelligence (AI)/machine learning (ML), product cases/issues, and integrated insights and analytics on one or more assets/resources across dimensions such as health/risk, stability, capacity, and aging. For example, the actionable tasks may include virtual assistance with in-time support, integrated guide-tour, the most efficient path (set of actions) to perform the actionable task, and/or suggesting the next action, task, and/or device. The actionable tasks 252 may involve network devices security vulnerabilities, license renewals, security reports, industry risk trends, expiration dates, etc.

In one or more example embodiments, the task engine 250 may combine contextual meaning of events and event sequences (user interactions) with contextual meaning of network devices and enterprise sites to generate targeted, customized actionable tasks specific to a particular network device and user actions. The task engine 250 combines user behavior (user interactions with the network domain) with network information (network device information, enterprise site information, and/or topology of the network domain) to generate meaningful, downstream tasks.

In one or more example embodiments, the network domain SSL service 120 uses, as input, one or more data sources (user interactions and/or network information). The data sources may include different types of information about users and/or the network domain. For example, the data sources include user interactions such as clicks and browsing, enterprise behavior (use patterns of the network/computing equipment and software 102(1)-102(N), at various enterprise sites 110(1)-110(N) of FIG. 1), product data obtained by monitoring products (the network/computing equipment and software 102(1)-102(N) of the enterprise), operational states of network devices, updates and configuration related data, faults, errors, enterprise data (purchase contracts, service contracts, warranty service agreements, and asset information i.e., data about network/computing equipment and software 102(1)-102(N), at various enterprise sites 110(1)-110(N)). Operational states of the network devices include static attributes (geolocation, role, product family, etc.) and information security (e.g., security advisory), software end of life/expiration, hardware end of life/expiration, etc. Device states include the state of the network domain itself, security information related to the one or more assets and the network domain, one or more network technologies being deployed using the one or more assets of the network domain, and/or progression of each deployment of the one or more network technologies.

The input data is embedded using event embedding component 210 and device embedding component 230 to form vectors (embedding structures). Machine learning is performed on the embedded structures. That is, event SSL engine 220 and/or the device SSL engine 240 uses mask modeling to determine contextual meaning and relationships among elements in the input data. Based on the foregoing, the task engine 250 generates various actionable tasks 252.

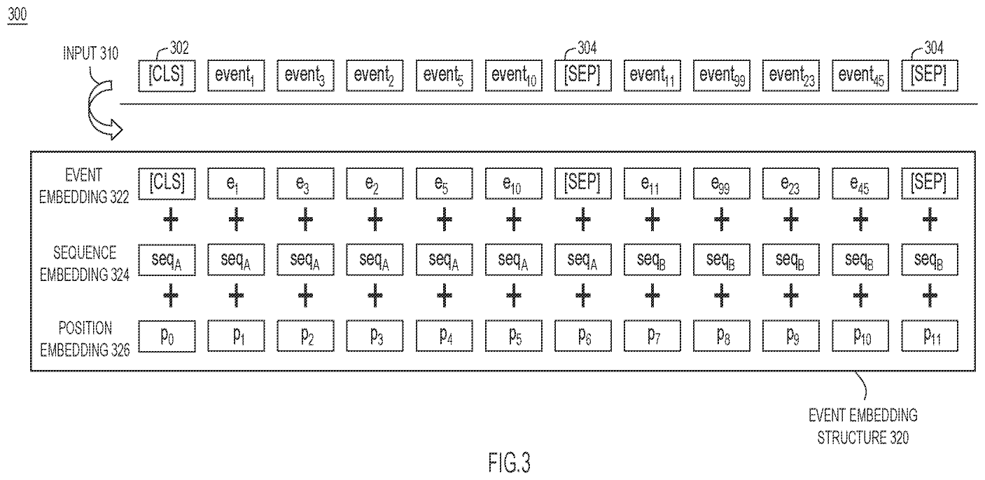

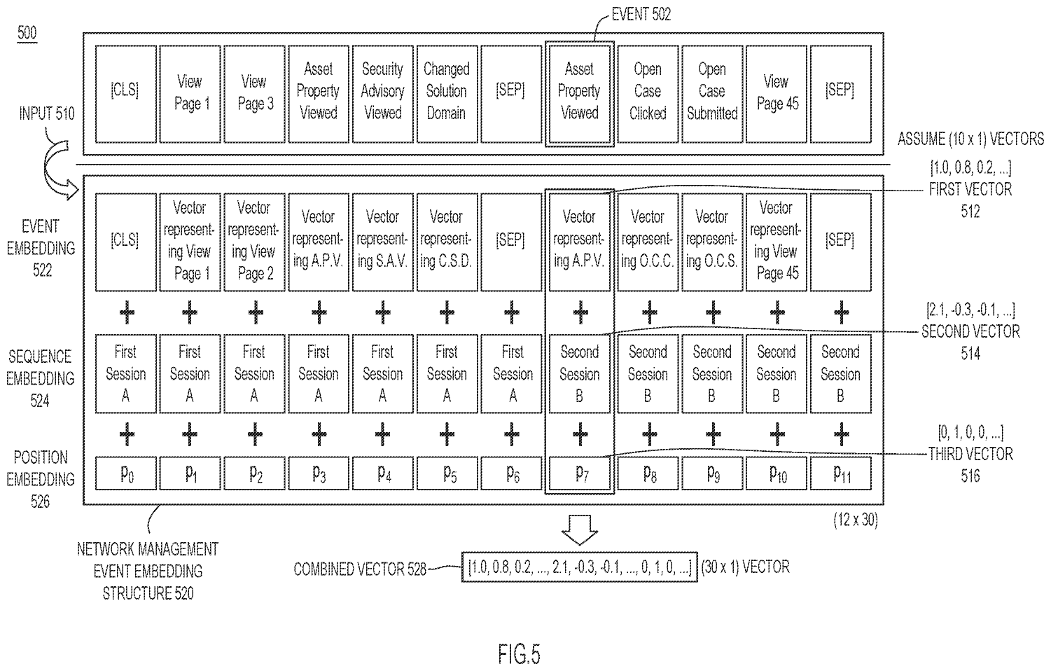

The network domain SSL service 120 performs ML such as SSL to network-specific domain data (click-through stream data and network information) and generates various actionable tasks 252 based on learned contextual meaning of the data. The components of the network domain SSL service 120 are described in further detail below with reference to FIGS. 3-14.

With continued reference to FIGS. 1 and 2, FIG. 3 is a diagram illustrating an event embedding process 300 in which user behavior information is embedded to form an event embedding structure, according to an example embodiment. The event embedding process 300 is performed by the network domain SSL service 120 executing on one or more servers, and more specifically by the event embedding component 210 of FIG. 2. The event embedding process 300 involves generating one or more of the event and sequence vectors based on user behavior information.

In one example embodiment, as a baseline, Bidirectional Encoder Representations from Transformers (BERT) model is deployed, which is a multi-layer bidirectional transformer encoder. The event embedding process 300 obtains input 310, which includes user interactions in a form of click-through stream data. For example, the input 310 includes sequence A (seq_{A}) and sequence B (seq_{B}). Each sequence includes a number of events such as event₁, event₃, event₂, . . . , event₉₉, etc. At the start of the input 310, a first special token 302 indicating a start of the sequence (classification “CLS”) is added and a second special token 304 indicating a sequence separator (SEP) is added between the sequences. Specifically, the first special token 302 signals the beginning of the click-through stream data and the second special token 304 signals that another event sequence is starting. In the event embedding process 300, each event has its own embedding, each token has its own position embedding, and each sequence has its own sequence embedding. The event embedding process 300 encodes the input 310 to generate the event embedding structure 320 that includes event embedding 322, a sequence embedding 324, and a position embedding 326.

With continued reference to FIGS. 1-3, FIG. 4A is a diagram illustrating generating the event embedding 322 which represents contextual meaning of a respective event, according to an example embodiment. In the event embedding 322, each event is encoded with the event's contextual meaning using the event SSL engine 220. The event embedding 322 provides information about the event itself.

For example, a first event₁ 402 is encoded into a first event vector e₁ 412 and a second event₂ 404 is encoded into a second event vector e₂ 414. Before iteratively training the event embedding structure 320 using the event SSL engine 220, the first event vector e₁ 412 and the second event vector e₂ 414 are random vectors. During training, the event embedding structure 320 updates the first event vector e₁ 412 and the second event vector e₂ 414 based on encountered errors. After training, the first event vector e₁ 412 and the second event vector e₂ 414 include respective contextual meanings.

With continued reference to FIGS. 1-4A, FIG. 4B is a diagram illustrating generating the sequence embedding 324 which represents contextual meaning of the sequence, according to an example embodiment. In the sequence embedding 324, events in the sequence are encoded to determine contextual meaning of the sequence using the event SSL engine 220. The sequence embedding 324 provides information about the sequence itself.

For example, the click-through stream data includes the sequence A (sequenceₐ) 422 and the sequence B (sequence_{b}) 424. The sequence A 422 and sequence B 424 are encoded into a first sequence vector (seqₐ) 432 and a second sequence vector (seq_{b}) 434. Before iteratively training the event embedding structure 320, the first sequence vector 432 and the second sequency vector 434 are random vectors. During training, performed by the event SSL engine 220, the event embedding structure 320 updates the first sequence vector 432 and the second sequency vector 434 based on encountered errors. After training, the first sequence vector 432 and the second sequence vector 434 include their respective contextual meanings. The sequence embedding 324 serves as an indicator which sequence an event belongs to.

With continued reference to FIGS. 1-4B, FIG. 4C is a diagram illustrating generating the position embedding 326 in which a position of an event within a sequence is encoded, according to an example embodiment. The position embedding 326 provides information about where in the sequence the event occurs. For example, the first event₁ 402 is at a first position (p1) 442 within the sequence A 422. The position embedding 326 serves as an indicator where in the sequence each event occurred.

Events may include one or more interactions or clicks made by a user in a network domain. Some non-limiting examples of the events include visiting a home page in the cloud portal 100, visiting one of the main pages such as asset property of an enterprise overview, etc. The events may include clicking on a particular button, selecting a particular tab, typing, etc. Sequences define a function, an activity, and/or network-specific action performed by a user in a network domain. Some non-limiting examples include opening a troubleshooting case, installing a security patch, changing a configuration of an asset, etc. Sequences include multiple events (e.g., open main page, then case page, type case details, submit case, etc.)

With continued reference to FIGS. 1 and 2, FIG. 5 is a diagram illustrating an embedding process 500 in which user interactions with the cloud portal 100 are encoded into a network management event embedding structure, according to an example embodiment. Each event token is represented as a vector forming the network management event embedding structure 520. Leveraging the network management event embedding structure 520 and model training techniques, the semantic meaning of user interactions with the cloud portal 100 are determined. The embedding process 500 is performed by the network domain SSL service 120 executing on one or more servers, and more specifically by the event embedding component 210 of FIG. 2.

Specifically, input 510 involves user behavior information including two sequences (sessions) of events (user interactions). In a first session A, user interactions include visiting the home page (page 1) of the cloud portal 100, then switching to an asset category (page 3), viewing asset property (A.P.V), viewing security advisory (S.A.V), and changing the solution domain (C.S.D). In a second session B, user interactions include viewing asset property (A.P.V.), clicking opening a case (O.C.C), submitting an open case (O.C.S), viewing page 45 of the cloud portal 100. This is just one non-limiting example of the input 510.

The input 510 is encoded into the network management event embedding structure 520 that includes an event embedding 522, a sequence embedding 524, and a position embedding 526. For example, an event 502 of viewing an asset property is embedded into (1) a first vector 512 that includes [1,0,0.8,0.2, . . . ] representative of the semantic or contextual meaning of the event 502 and (2) a second vector 514 indicative of the session in which the event 502 occurred. Specifically, the second vector 514 may include [2.1, −0.3, −0.1 . . . ] representing that it occurred in the second session B. Additionally, the position of the event 502 in the second session B is embedded into a third vector 516 such as [0,1,0,0 . . . ] representing that it is the seventh event (p7). The first vector 512, the second vector 514, and the third vector 516 are concatenated into a combined vector 528 that captures the information about the user interaction such as where and what occurred and the dependency of the event and its order in the sequence. The combined vector 528 is indicative of the contextual meaning of the event 502 such as when is it performed, for what purpose, etc. By encoding the click-through steam data (user interactions), the network domain SSL service 120 learns user's intentions to generate various actionable tasks in the network domain.

In one or more example embodiments, another layer of embedding may be generated. Another layer involves adding a group or a class similarity to an event embedding structure. In a natural language processing, a paragraph or a document is a sequence of sentences. In the network domain, the click-through streams are grouped into a bucket. If a bucket of click-through streams originated from the same entity (e.g., User/Persona/Company/etc.), this fact can be leveraged for generating meaningful recommendations and/or actionable tasks. Unlike the natural language processing where the order of the sentences is fixed, the event embedding component 210 dynamically, flexibly and/or on-the-fly generates various groupings and their hierarchies.

With continued reference to FIGS. 1-4C, FIG. 6A is a diagram illustrating a group embedding process 600 in which various event sequences are classified into one or more groups, according to an example embodiment. The group embedding process 600 is performed by the network domain SSL service 120 executing on one or more servers, and more specifically, by the event embedding component 210 of FIG. 2.

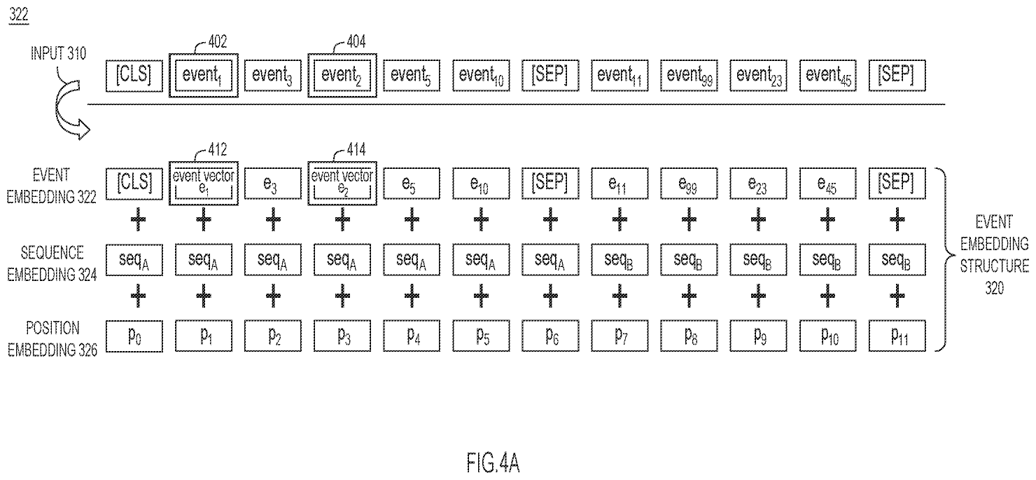

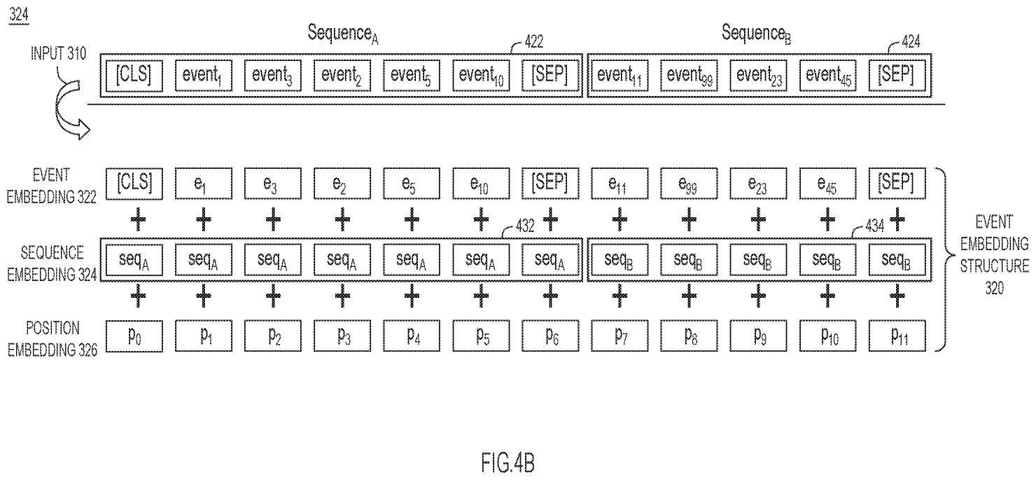

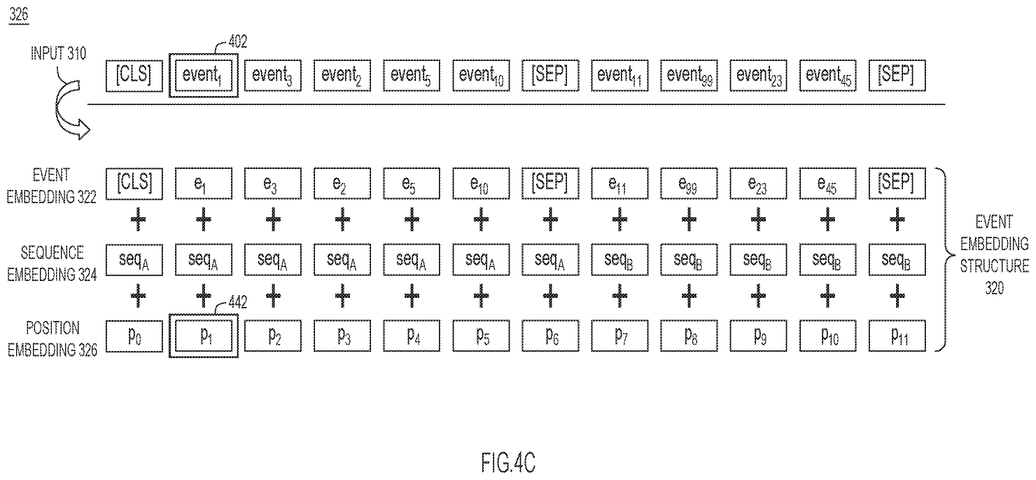

A plurality of event sequences 610a-k are obtained as input. The event sequences 610a-k are generated by various entities/users. Each of the event sequences 610a-k is indicative of a sequence of events. For example, a first click-through stream 1 610a represents the sequence A 422 of FIG. 4B, a second click-through stream 610b represents the sequence B 424 of FIG. 4B, and a third click-through stream 610f represents a third event sequence, a fourth click-through stream 610g represents a fourth event sequence (interactions of a second user B), a fifth click-through stream 610h represents a fifth event sequence (also interactions of the second user B), etc. The event sequences 610a-k are grouped into “buckets” based on one or more attributes. If a bucket of a set of click-through streams is obtained from the same individual user (same user identity), this may be encoded into an event embedding structure. Buckets are indicative of a grouping of user interactions based on one or more shared attributes (e.g., user identity). The click-through streams are grouped flexibly using machine learning (ML). The groupings are customizable for various use cases.

In one example embodiment, the click-through streams (the event sequences 610a-k) are grouped by individual users representing user level buckets 612a-p. For example, the first click-through stream 1 610a, the second click-through stream 610b, and a third click-through stream 610f are grouped into a first user bucket 612a indicating that the user interactions are performed by the individual user A. The fourth click-through stream 610g and the fifth click-through stream 610h are grouped into a second user bucket 612b, etc. Each of the user level buckets 612a-p represents respective user's behavior.

Additionally, the click-through streams (the event sequences 610a-k) are grouped per user role or persona represented by persona level buckets. Persona or role attribute indicates that a set of click-through streams are performed by one or more users that have the same or similar role within an enterprise. For example, the role may be a network security specialist operator, a network administrator, a configuration manager, a researcher, an enterprise network planner, a developer, a network engineer, etc. If the click-through streams are grouped per user role or persona, each bucket represents each role/persona's behavior (as a whole). For example, the first click-through stream 1 610a, the second click-through stream 610b, and a third click-through stream 610f (c) performed by the first user A and the fourth click-through stream 610g and the fifth click-through stream 610h performed by the second user B are grouped into a persona level bucket 614a. The persona level bucket 614a represents the network behavior of a network security specialist operator.

Moreover, the click-through streams (the event sequences 610a-k) are grouped per enterprise level buckets. Each enterprise level bucket represents enterprise's behavior (as a whole). For example, a set of click-through streams that are performed by users of a company I is grouped into an enterprise level bucket 616a.

Also, the click-through streams (the event sequences 610a-k) are grouped per geolocation and/or industry type. In this case, each bucket represents the geolocation and/or industry behavior (as a whole). For example, click-through streams of company III and company IV (two enterprises) are grouped into a geolocation or industry level bucket 618a that represents behavior of U.S. based small finance enterprises.

The above examples are just a few non-limiting use case scenarios. The group embedding process 600 involves embedding the event sequences 610a-k into various groups based on one or more discovered attributes. Grouping information for the click-through stream data is generated by grouping the event sequences 610a-k into various groups based on at least one attribute. While attributes may include an identity of an individual user that generated the respective event or sequence, a role or persona of the user within the network domain, an identity of an enterprise of the user, a geolocation associated with the user or enterprise, and/or type of an enterprise, attributes are not limited thereto. The attributes may be determined by the event embedding component 210 of FIG. 2 as it determines contextual meanings of events and/or event sequences.

With continued reference to FIGS. 1-4C and 6A, FIG. 6B is a diagram illustrating an attribute discovery process 620 in which one or more attributes for grouping event sequences are determined, according to an example embodiment. The attribute discovery process 620 is performed by the network domain SSL service 120 executing on one or more servers, and more specifically, by the event embedding component 210 of FIG. 2.

The attribute discovery process 620 involves analyzing the event sequences 610a-k to determine one or more similar attributes or characteristics. For example, using machine learning (ML), a set of event sequences are clustered based on one or more similar attributes. The attribute (grouping criteria or grouping rule) is determined using ML clustering and is not a pre-defined element or a user input component. In other words, the attribute(s) are determined dynamically/on the fly/during runtime by clustering the event sequences 610a-k to detect similarities.

In one or more example embodiments, the attributes are determined by analyzing the event sequences 610a-k using unsupervised clustering. In the unsupervised clustering, the click-through stream data (the event sequences 610a-k) are grouped into various buckets based on determined similarities. Specifically, distinctive behaviors are determined in each cluster using machine learning. The distinctive behaviors are not defined manually or by an input criteria. For example, a Sequence Group A 622 behaves differently from another Sequence Group B 624, thereby grouping rule are generated using unsupervised clustering. The Sequence Group A 622 includes the first click-through stream 610a, the second click-through stream 610b, a sixth click-through stream 610i and a sixth click-through stream 610i. The Sequence Group A 622 may represent operations or actions related to configuring one or more assets in the network domain. The Sequence Group B 624 includes the fourth click-through stream 610g, the fifth click-through stream 610h, and a seventh click-through stream 610k. The Sequence Group B 624 may represent operations or actions for troubleshooting performance of one or more network(s) in the network domain. The attributes need not be hard-coded rules and are discovered by unsupervised learning such as clustering and are leveraged as a machine learning model input. The grouping information may then also be encoded into an event embedding structure.

With continued reference to FIGS. 1-4C, 6A, and 6B, FIG. 6C is a block diagram illustrating an event embedding structure 630 in which grouping information is encoded therein, according to an example embodiment.

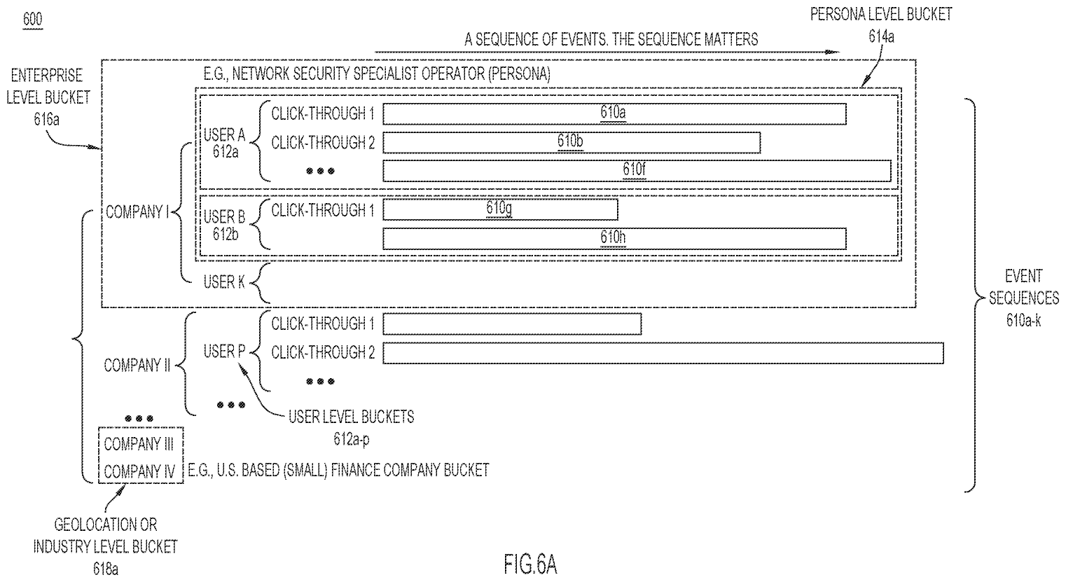

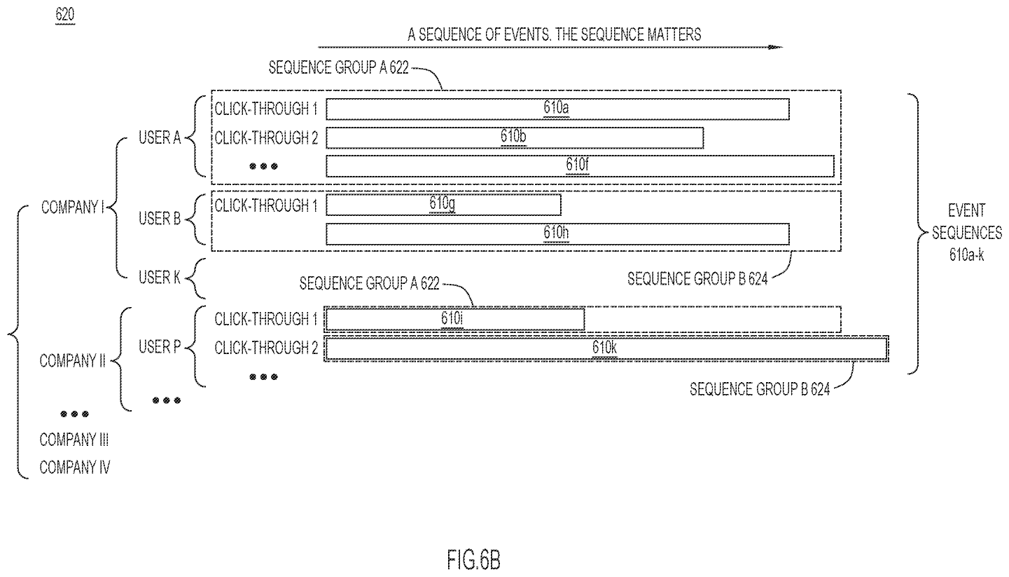

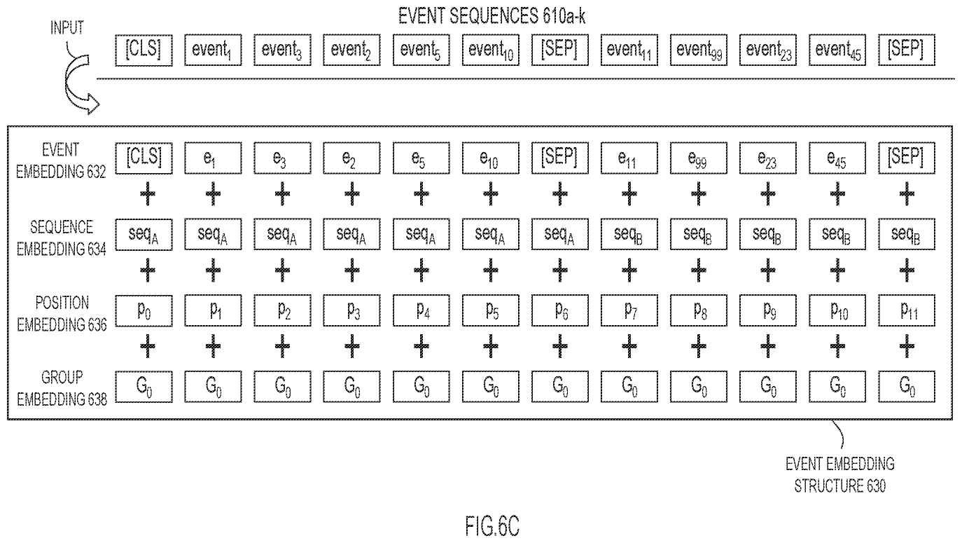

Specifically, the event embedding structure 630 involves four or more encoded elements or components for event sequences 610a-k of FIGS. 6A and 6B. The encoded elements or components include: (1) event embedding 632 that stores each event's contextual meaning, (2) sequence embedding 634 that serves as an indicator which sequence an event belongs to, (3) position embedding 636 that serves as an indicator where in the sequence each event appears, and (4) group embedding 638 that indicates where in the similar group this sequence comes from i.e., a common attribute. Group embedding 638 may indicate that the event is obtained from the same user, persona, enterprise, etc. While only one group embedding 638 is shown, there may be multiple group embeddings for various attributes (e.g., whether the event sequences are from the same user, the same persona, the same enterprise, the same role/function, etc.). The attributes are representative of learned relationships between click-through events/sequences when the training data is set and organized. The relationships and contextual meanings are determined by the event SSL engine 220 of FIG. 2, which applies machine learning to the event embedding structure 630, as detailed below.

The machine learning may be self-supervised machine learning that includes Masked Event modeling (MEM) and an Adjacent Sequence Prediction (ASP). Specifically, the self-supervised machine learning includes iteratively training an event embedding structure (e.g., the event embedding structure 630) by replacing an element in the embedding structure with a masked token to determine contextual meaning of the element and one or more relationships between elements. Contextual meaning of the element may define user's behavior and/or intent e.g., user performs the following interactions to configure a network device with setting A. Relationships between elements further define user's behavior and/or intent e.g., user configures the network device with the setting A based on opening a troubleshooting case.

With continued reference to FIGS. 1-6C, FIG. 7 is a diagram illustrating performing masked event modeling (MEM) 700 of an event embedding structure to determine contextual meaning of events, according to an example embodiment. The MEM 700 is performed by the network domain SSL service 120 executing on one or more servers, and more specifically, by the event SSL engine 220 of FIG. 2.

The MEM 700 is fill-in-the-blank-style denoising objectives in which an event embedding structure 710 (input model) is trained to learn events, event sequences, relationships, etc. Specifically, the MEM 700 involves recovering missing or corrupted event(s) in the event embedding structure 710. These denoising objectives predict missing or corrupted event(s) in the input (the event embedding structure 710). Based on a large amount of click-through stream data (input data), the MEM 700 determines events that are hidden or missing in the input model to fill in the blank(s). The MEM 700 leverages the following information, which is encoded in the event embedding structure 710 (the input model): neighboring events, how frequently an event occurs, where the event occurs in a click-through stream, and where this event sequence comes from (e.g., same user, same persona, same entity, etc.). By iteratively training the event embedding structure 710, contextual meaning of the events, event sequences, groupings (common attributes), etc. are determined.

The MEM 700 involves replacing the event 2 in the event embedding structure 710 with a masked token 712 (mask). At 720, the MEM 700 performs self-supervised machine learning to determine which event is masked with the masked token 712. By performing self-supervised learning, event candidates 730 with predicted probability are generated. Specifically, event candidates 730 include event 2, event 11, event 45, event9, and event 23. Event 2 has the highest probability of being the correct event. Based on the foregoing, the MEM 700 outputs event 2 as the predicated event 732.

In one example, for the masked token 712, the MEM 700 may iterative train the event embedding structure 710 as follows. For approximately 15% of the events in the event embedding structure 710, 80% of the time, the event is replaced with the masked token 712, 10% of the time, the event is replaced with another random event (not shown), and 10% of the time, the event remains unchanged (not shown). The MEM 700 determines for each of the masked token 712 whether the event is unchanged from the original event and/or the most probable event for the masked token 712 when the event was changed. Additionally, the MEM 700 further determines whether the masked token 712 replaces one or multiple events (e.g., several events in the event sequence) and whether the masked token 712 was replaced by another event token. The MEM 700 generates various uncertainties in the event embedding structure 710 to learn contextual representation of every input event, event sequence, etc.

Uncertainties force the MEM 700 to learn contextual representation of every input event in the event embedding structure 710 and to correctly determine if the masked token 712 is an unchanged event, corrupted event, replaced by the masked token 712 (hidden event), or an incorrect event. These uncertainties indicate to the MEM 700 that the “unmasked” token is not always correct; hence, the MEM 700 also determines if the event is unchanged or replaced by another event.

In addition to determining contextual meanings of the events in the event embedding structure 710, the self-supervised machine learning involves learning one or more relationships between various user interactions represented by event sequences. Specifically, the adjacent sequence prediction (ASP) process is performed to determine whether there is one or more relationships between various event sequences.

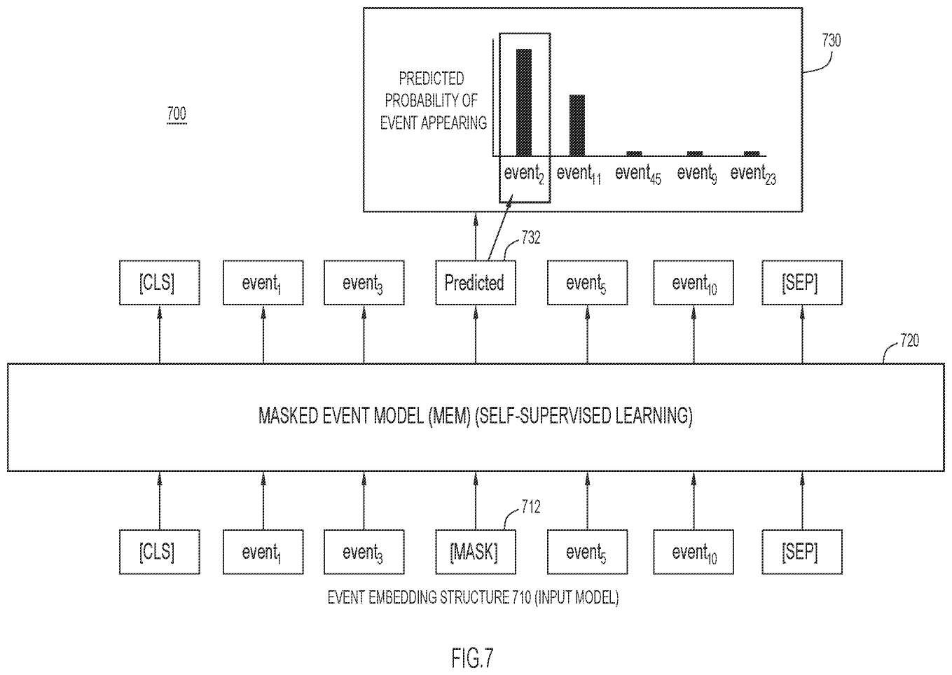

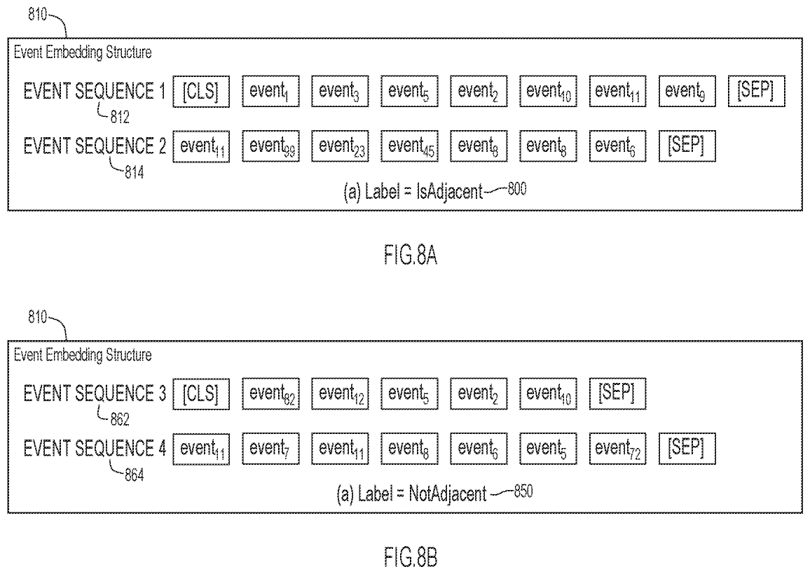

With continued reference to FIGS. 1-7, FIGS. 8A and 8B are diagrams illustrating performing adjacent sequence prediction (ASP) self-supervised learning to determine whether event sequences of an event embedding structure are related, according to an example embodiment. Specifically, FIG. 8A is a view illustrating an adjacency label 800 being assigned to event sequences determined to be related by performing the ASP of self-supervised machine learning, according to an example embodiment and FIG. 8B is a view illustrating not adjacent label 850 being assigned to event sequences determined to be unrelated by performing the ASP of self-supervised machine learning, according to an example embodiment. ASP is performed on an event embedding structure 810 (e.g., the event embedding structure 710 of FIG. 7) to determine if there is a relationship between event sequences. That is, whether the event sequences share at least one attribute e.g., performed by the same entity, within same geographic area, similar functional domain, etc. The ASP is performed by the network domain SSL service 120 executing on one or more servers, and more specifically, by the event SSL engine 220 of FIG. 2.

In FIG. 8A, a first event sequence 812 and a second event sequence 814 are selected from the event embedding structure 810. The first event sequence 812 and the second event sequence 814 are two random event sequences of the event embedding structure 810. By iteratively training the event embedding structure 810 using the ASP, one or more relationships between the first event sequence 812 and the second event sequence 814 may be determined. If a relationship is determined, the adjacency label 800 is assigned. Related event sequences may involve event sequences performed by the same entity (e.g., user, persona, company). This relationship may be encoded into the event embedding structure 810 as grouping information.

In FIG. 8B, a third event sequence 862 and a fourth event sequence 864 are selected from the event embedding structure 810. While iteratively training the event embedding structure 810 using the ASP, no relationships between the third event sequence 862 and the fourth event sequence 864 are detected. If the two sequences are unrelated, not adjacent label 850 is assigned. If the two sequences are unrelated, a zero vector may be encoded in the event embedding structure 810 as the grouping information.

ASP supports flexible grouping of event sequences. Groupings may be dynamic based on discovering one or more shared attributes between various event sequences in the event embedding structure 810. The groupings or shared attributes are derived from the event embedding structure 810 itself. Since flexible event sequence groupings are supported, the event embedding structures may be iteratively trained using multiple grouping schemes and/or combined grouping schemes.

For example, event sequences from the same user A are grouped together and assigned the adjacency label 800 of FIG. 8A and event sequences from other users are then assigned not adjacent label 850 of FIG. 8B. The ASP determines which event sequences are from the same user A. The event embedding structure 810 is further analyzed to determine if two sequences are from another user B, from the same persona, the same company, the same industry, etc. By iteratively training the event embedding structure 810 using ASP, one or more relationships between various user interactions and/or operations are determined such as these two event sequences are performed by different users associated with the same enterprise, these two event sequences are performed by users having the same persona but associated with two different enterprises, etc.

With continued reference to FIGS. 1-8B, FIG. 9 is a diagram illustrating performing self-supervised machine learning 900 of an event embedding structure to determine contextual meaning of events and event sequences, according to an example embodiment. The self-supervised machine learning 900 is performed by the network domain SSL service 120 of FIG. 1 executing on one or more servers, and more specifically, by the event SSL engine 220 of FIG. 2. The self-supervised machine learning 900 involves iteratively training an event embedding structure 910 (having a large number of event sequences) by performing the MEM 920 and the ASP 930.

In the MEM 920, an event is replaced with a masked token 922 or another token 924 in the event embedding structure 910. If an event is replaced with the masked token 922 or hidden with another token 924 and this event appears in multiple click-through streams in the event embedding structure 910 with context around it, by performing the MEM 920, the meaning for the masked event is determined. By learning the contextual meaning of the masked event, when the event is masked, the MEM 920 correctly determines the masked or missing event. That is, the event is determined with high probability/confidence level.

Next, by performing the ASP 930, relationship(s) or shared attributes 932 between various event sequences in the event embedding structure 910 are determined. For example, shared attributes 932 may include one or more of individual user identity, persona or role of the user, enterprise associated with the user, geolocation of the user, industry or field associated with the user, etc.

In one or more example embodiments, the self-supervised machine learning 900 may include masking contiguous span of events for a deeper understanding of the contextual meaning. In one or more example embodiments, the self-supervised machine learning 900 may include providing a number of masked events and/or determining how many events are masked. In one or more example embodiments, the self-supervised machine learning 900 may include generating labels, clustering, and/or using neural networks to learn the contextual meaning of events and event sequences in the event embedding structure 910.

With continued reference to FIGS. 1-9, FIGS. 10A and 10B are views illustrating contextual meaning of events 1000 and contextual meaning of event sequences 1050, respectively, according to one or more example embodiments. The contextual meaning of events 1000 and/or the contextual meaning of the event sequences 1050 are examples of the model output 226 of FIG. 2, generated by the event SSL engine 220 of FIG. 2.

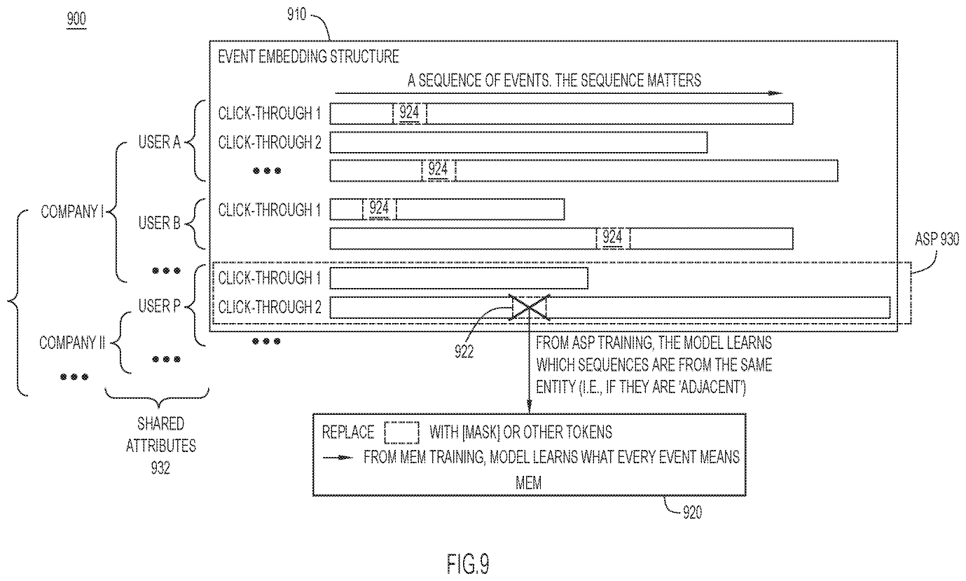

The learned events and sequence embedding encodes information about semantic or contextual meanings of events and event sequences such that similar events are in a similar region of an embedding space. This learned embedding is key output, which essentially is the knowledge about user's behavior and/or user's intentions obtained by performing self-supervised machine learning 900 of FIG. 9.

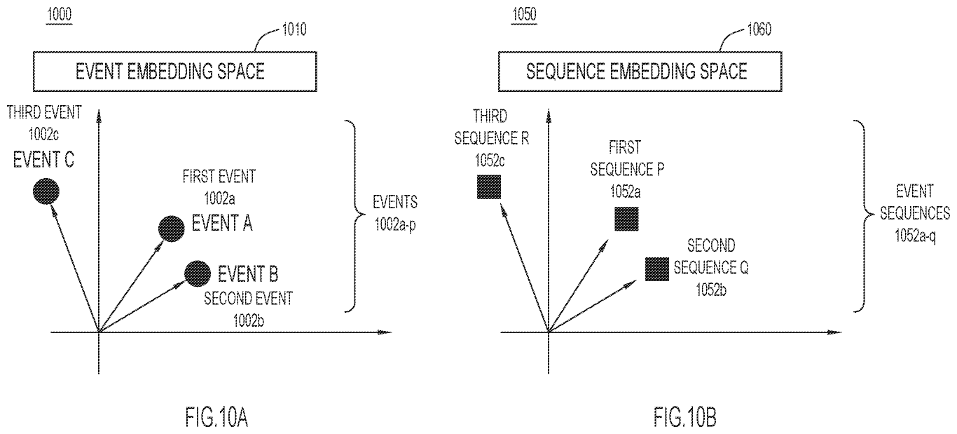

In FIG. 10A, the contextual meaning of events 1000 is represented by mapping a plurality of events 1002a-p in an event embedding space 1010. A first event 1002a (event A) and a second event 1002b (event B) are similar events and as such are positioned closer to each other in the event embedding space 1010. On the other hand, a third event 1002c (event C) has a different contextual meaning from the first event 1002a and the second event 1002b. As such, the third event 1002c is at a substantial distance from the first event 1002a and the second event 1002b in the event embedding space 1010.

Similarly, in FIG. 10B, the contextual meaning of event sequences 1050 is represented by mapping a plurality of event sequences 1052a-q in a sequence embedding space 1060. Similar event sequences such as first sequence P 1052a and second sequence Q 1052b are close to one another in the sequence embedding space 1060, when compared to another sequence (a third sequence R 1052c), which has a different meaning (or is unrelated to other event sequences).

Based on understanding contextual meanings of events and/or event sequences, various downstream or actionable tasks may be generated via subsequent ML models. Actionable tasks include event and/or event sequence clustering, sequence summarization, next event predictions, etc. For example, at least one actionable task for performing the one or more actions may include generating a shortcut for executing the one or more actions that relate to a configuration or management of the network domain. As another example, the at least one actionable task may include generating guided support for performing the at least one actionable task by sequentially providing or executing a next action from the one or more actions of the task. As another example, the actionable task may include generating the shortest path (least number of actions and/or simplest actions) for performing the task. As another example, behavioral similarities between one or more user interactions are determined based on the contextual meaning of the event and/or event sequences. An action of an actionable task is then generated and relates to a similar user behavior.

In one or more example embodiments, in addition to determining contextual meaning of user interactions that define user behavior and intent, contextual meaning of the network domain may be determined using self-supervised machine learning. Contextual understanding (semantic meaning) of the network domain is obtained by embedding and analyzing network information.

With continued reference to FIGS. 1 and 2, FIG. 11 is a diagram illustrating a network embedding process 1100 in which network information is embedded to form a network embedding structure, according to an example embodiment. The network embedding process 1100 is performed by the network domain SSL service 120 executing on one or more servers, and more specifically, by the device embedding component 230 of FIG. 2. The network embedding process 1100 involves generating one or more of device and site vectors based on network information.

In one example embodiment, as a baseline, Bidirectional Encoder Representations from Transformers (BERT) model is deployed, which is a multi-layer bidirectional transformer encoder and is similar to the embedding of FIG. 3. The network embedding process 1100 obtains input 1110 and encodes it into a network embedding structure 1120.

Input 1110 is network information about the network domain such as identification and/or characteristics of a plurality of devices 1112a-r (network/computing equipment and software 102(1)-102(N) located on various enterprise sites 110(1)-110(N) of FIG. 1). When encoding the input 1110, a first special token 1114 indicating a start of the sequence (classification “CLS”) is added and a second special token 1116 indicating a site separator (SEP) is added between various enterprise sites.

In the network embedding process 1100, each device has its own embedding, each token has its own position embedding, and each site has its own site embedding. The network embedding structure 1120 includes device embedding 1122, a site embedding 1124, and a topology embedding 1126. The device embedding 1122 and the site embedding 1124 are similar to event and sequence embeddings described above with reference to FIGS. 3, 4A, and 4B. That is, semantic information is learned about the network domain by deriving device embedding 1122 and the site embedding 1124 based on viewing a network as a basket of connected devices, as shown at 1130. The contextual meaning of devices and sites are learned via self-supervised machine learning. For example, a particular type of device (certain device type, role, product family) that is chosen as an example can appear in the site A in an Enterprise I. The same device may also appear in the site B in Enterprise I, Site P in Enterprise II, etc.

Instead of the position embedding of FIGS. 3 and 4C, topology embedding 1126 is generated. The topology embedding 1126 encodes topology of the network domain. The topology embedding 1126 includes connection information between various devices and/or sites. For each device, the connection information is encoded, at its simplest form, with an adjacency list or an adjacency matrix by viewing a device as a node and a connection between devices as an edge. The topology embedding 1126 may be represented as a topology vector 1140. For example, a first device 1132 (d1) has the topology vector 1140 as [0,0, 1,1, 1,0,0], meaning that the first device 1132 is connected to a third device 1134 (d3), a second device 1136 (d2), and a fifth device 1138 (d5), as shown at 1130.

With continued reference to FIGS. 1, 2, and 11, FIG. 12 is a diagram illustrating a topology embedding process 1200 in which device and site connection information is encoded, according to an example embodiment. The topology embedding process 1200 is performed by the network domain SSL service 120 executing on one or more servers, and more specifically, by the device embedding component 230 of FIG. 2. The topology embedding process 1200 involves generating connection information for the network domain 1210.

The network domain 1210 includes information about a plurality of network devices, enterprise sites, and/or connections between various enterprise sites and devices. At 1220, the network information about the network domain 1210 is encoded into an adjacency matrix 1230. For example, if two devices are connected, then the value is 1 (0 otherwise). The adjacency matrix 1230 is one of the forms of mathematically representing the network domain 1210. While the adjacency matrix 1230 only shows 0 and 1 for the relationship of two devices, this is but one example. The adjacency matrix 1230 may be augmented to encode additional information such as the type of nodes (network devices), the distance from one another, and/or the strength of the relationship (direct connection, main connection, latency, etc.). In one example, one-hot-encoding for a single device is performed to form the adjacency matrix 1230.

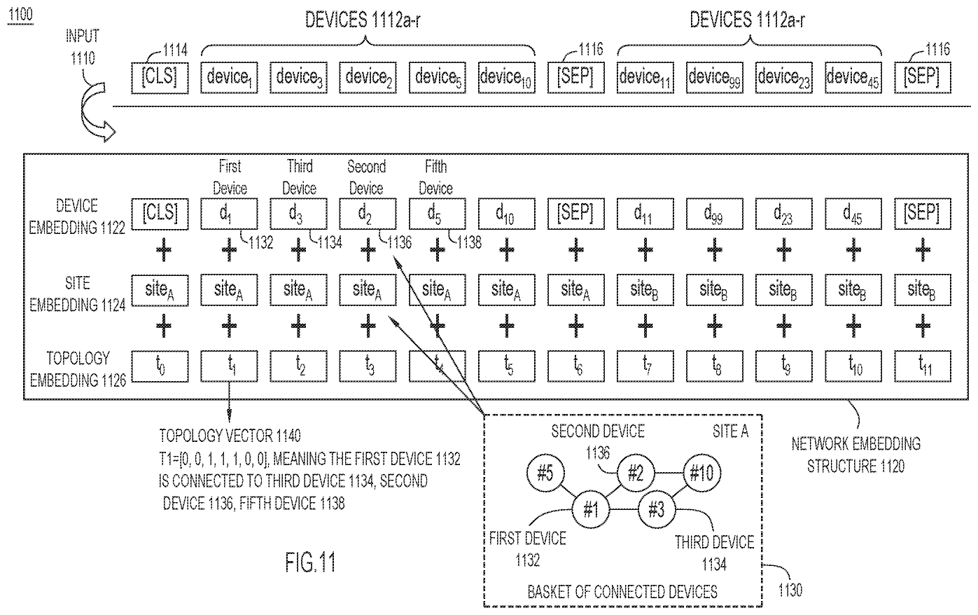

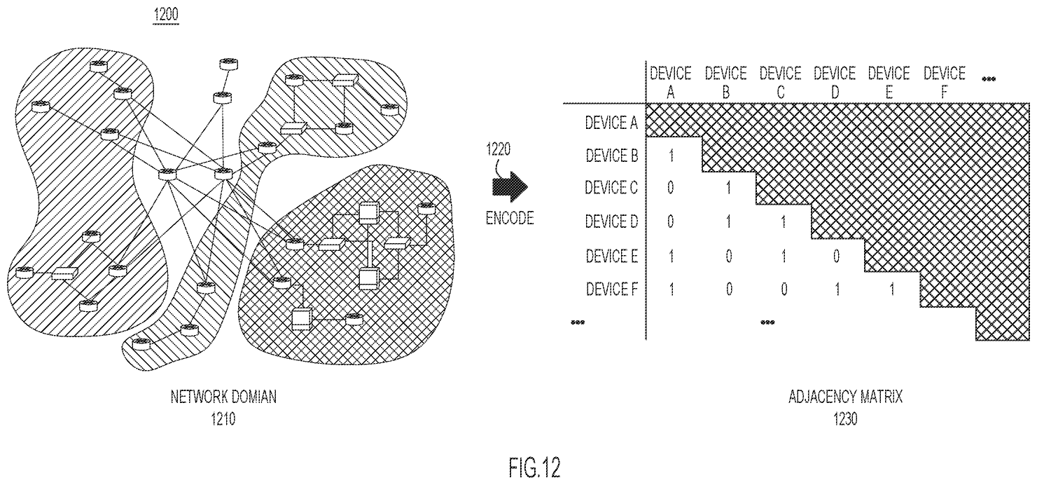

An adjacency list or the adjacency matrix 1230 is only one example embodiment. In another example embodiment, node embedding such as DeepWalk embedding and/or Node2Vec encoding are used to encode the topology of the network domain 1210. Node embedding may provide more semantically meaningful information about each device and may be applied instead of or in addition to the one-hot encoding of FIG. 11 with the learned node embedding.

The topology embedding 1126 is added to the network embedding structure 1120 of FIG. 11. The network embedding structure 1120 is the model input 234 of FIG. 2. The device SSL engine 240 performs the self-supervised learning of the network embedding structure 1120 to learn contextual meaning of the network domain 1210. That is, leveraging the network embedding structure 1120, and the self-supervised learning, semantics and/or contextual meanings of the devices and sites in the network domain 1210 are determined.

With continued reference to FIGS. 1, 2, 11, and 12, FIG. 13 is a diagram illustrating performing self-supervised machine learning 1300 of a network embedding structure to determine contextual meaning of the network domain, according to an example embodiment. The self-supervised machine learning 1300 is performed by the network domain SSL service 120 of FIG. 1 executing on one or more servers, and more specifically, by the device SSL engine 240 of FIG. 2. Similar to self-supervised learning of an event embedding structure of FIG. 9, the self-supervised machine learning 1300 involves iteratively training a network embedding structure 1310 by performing mask device modeling (MDM) 1320 and adjacent site prediction (ASP) 1330.

The MDM 1320 involves replacing a device with a mask token 1322 or corrupting a device(s) randomly illustrated at 1324. The MDM 1320 further involves determining whether (a) the device is unchanged from the original device, (b) the most probable device for the masked device, (c) number of devices that were masked (one device, two devices, three devices, etc.), and/or (d) is a device replaced by another device in the network embedding structure 1310.

In one example, for a selected device (roughly 15% of the devices in the network domain), 80% of the time, the selected device is replaced with the mask token 1322, 10% of the time, the selected device is replaced with another random device illustrated at 1324, and 10% of the time, the device is maintained unchanged illustrated at 1326. By generating these uncertainties, the MDM 1320 determines a contextual representation of every input device, correctly determines if this device(s) was either unchanged, corrupted, or simply replaced by another device. These uncertainties also send a signal to the MDM 1320 that the unmasked devices are not always correct; hence, the MDM 1320 involves determining if the device is unchanged or replaced by another device(s).

The ASP 1330 determines one or more relationships (connections) between various enterprise sites and/or devices in the network domain. Similar to adjacent sequence prediction (ASP) of FIGS. 8A-9, the ASP 1330 learns the relationship(s) between various network sites. For example, network sites from the same enterprise may be grouped together and obtain is adjacent label of FIG. 8A. Network sites from other enterprises are then labeled with a not adjacent label of FIG. 8B. The ASP 1330 iteratively trains the network embedding structure 1310 to determine if two sites are from the same enterprise or not. That is, the ASP 1330 analyzes the network embedding structure 1310 to generate relationship information such as a first enterprise site A 1334 and a second enterprise site B 1336 belong to an enterprise network I 1338. This is but one non-limiting example of a relationship determined by the ASP 1330. Other relationships may include but are not limited to geographic region, industry type, size and functionality of an enterprise network, etc.

With continued reference to FIGS. 1, 2, 11-13, FIGS. 14A and 14B are views illustrating contextual meaning of devices 1400 and contextual meaning of network sites 1450, respectively, according to one or more example embodiments. The contextual meaning of devices 1400 and/or the contextual meaning of the network sites 1450 are examples of the model output 246 of FIG. 2, generated by the device SSL engine 240 of FIG. 2.

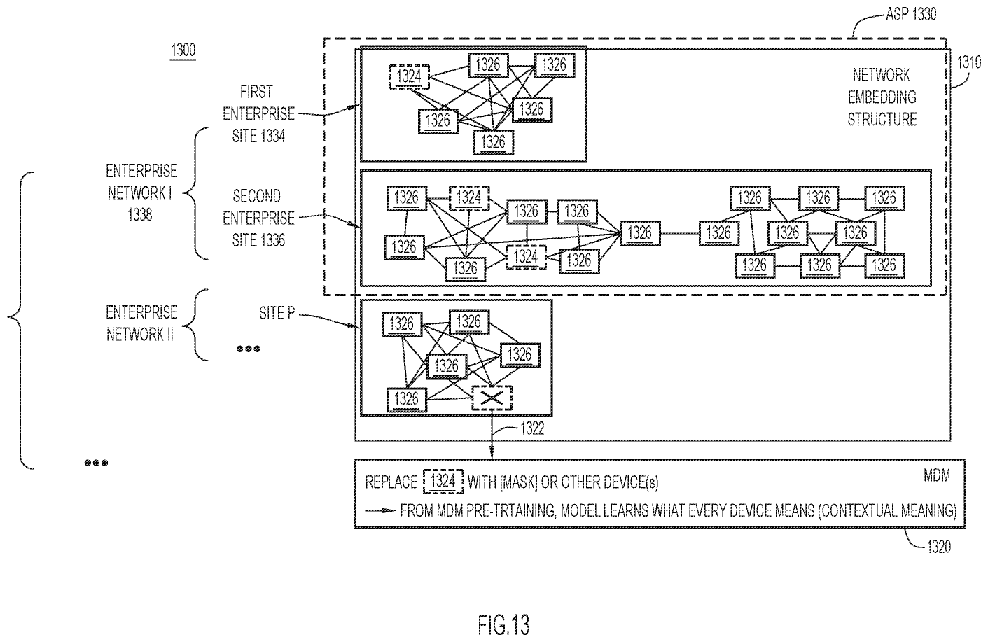

The learned devices and network sites embedding encodes information about semantic or contextual meanings of the network domain such similar devices that are in a similar geographic region of a network device embedding space 1410 or network sites that belong to the same enterprise network of a network-site embedding space 1460. This learned embedding is key output, which essentially is the knowledge about the network domain, generated by performing self-supervised machine learning 1300 of FIG. 13.

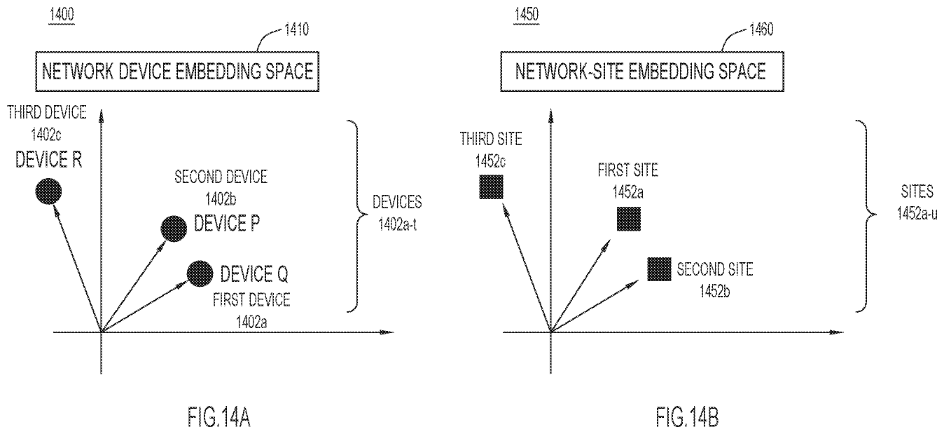

In FIG. 14A, the contextual meaning of devices 1400 may include mapping a plurality of devices 1402a-t in the network device embedding space 1410 such that a first device 1402a and a second device 1402b are closer in the network device embedding space 1410 when compared to a third device 1402c, which has a different semantic meaning. The network device embedding space 1410 may represent physical proximity of the devices, functional similarity of the devices, software configuration similarity, similar security vulnerability, license expiration/due for renewal, etc.

In FIG. 14B, the contextual meaning of the network sites 1450 may include mapping a plurality of network sites 1452a-u in the network-site embedding space 1460 such that a first network site 1452a and a second network site 1452b are closer in the network-site embedding space 1460 when compared to a third network site 1452c, which is a different network site e.g., belongs to another enterprise, in a different geographic region, has a significantly different quantity or quality of network devices, etc.

By understanding contextual meaning of network devices and network sites, various downstream or actionable tasks are generated via subsequent ML models. For example, generating actionable tasks may involve device/site clustering, outlier device detection, etc.

Some examples of generating actionable tasks based on contextual meanings of user interactions and/or network information are now described. In one or more example embodiments, actionable tasks are generated based on both contextual meaning of the user behavior information obtained by performing self-supervised learning of the event embedding structure and contextual meaning of the network domain obtained by performing self-supervised learning of the network embedding structure.

FIG. 15A is a diagram illustrating a device embedding space 1500 with contextual meaning of user behavior encoded therein, according to an example embodiment.

At 1510, similar devices are identified in the device embedding space 1500. For example, similar devices are devices with similar contextual meaning in the device embedding space 1500 such as similarly functioning devices e.g., network routers.

At 1520, contextual meaning of user behavior information is added therein to determine (a) if users are using their devices in a similar way and/or (b) whether there are a different set of events prevalent in each user group. Specifically, a first user group 1522 performs a first set of actions or interactions (events 1, 2, 3) and a second user group 1524 performs a second set of actions or interactions (events 4 and 5). The activities, performed by the users on similar devices, are thus different and these differences are detected. Thereby, a deep understanding of how users interact with their devices are obtained and more targeted actionable tasks are generated. Based on the contextual meaning of user actions added to the device embedding space 1500, it is determined that similar devices are used differently by the two user groups.

FIG. 15B is a diagram illustrating another device embedding space 1550 with contextual meaning of user behavior encoded therein, according to another example embodiment. Another device embedding space 1550 leverages contextual meaning of the network domain in conjunction with contextual meaning of user behavior (events and event sequences understanding) to generate actionable tasks.

At 1560, similar devices to the ones used by the first group 1562 are identified. At 1570, activities performed on these similar devices are determined. For example, activities may include tackling security vulnerabilities, field notices, handling defects, etc. in these similar devices. For a security vulnerability, instead of manually reviewing a list of devices with vulnerable product type/software/configurations, the network domain SSL service 120 generates a list of similar devices 1582 that potentially need network engineer's attention while tackling an issue for a device. For example, an actionable task 1580 may include a notification that if looking at these devices to tackle the issue (extracted intention from event embedding), there could be other similar devices 1582 (extracted similarity between devices) with a similar issue. These similar devices should be reviewed to determine if similar issue (security vulnerability) exists.

In one or more example embodiments, the network domain SSL service 120 determines how the user-device interactions appear and generates actionable tasks based on these determinations. The actionable tasks may involve performing or suggesting similar activities to the activities performed by other users for similar devices or providing various action paths for performing an actionable task based on multiple different ways different set of users interact with similar devices, etc.

In one or more example embodiments, the embedding structures may be improved by filtering noise from noisy input data. Unlike human-spoken or written sentences, event sequences may be quite noisy. For example, users may click many places without a clear understanding of where to click for their goal (“browsing” or “exploring”). Accordingly, noise data needs to be filtered out from the input data i.e., event sequences are denoised. For example, when a website user interface (UI) is designed, an intended way of user journey is provided e.g., actionable task is performed by a plurality of defined actions such as clicking a, b, and then c. Deviations from the user journey can be denoised by pre-processing the raw data. As another example, users may be segmented into novice users and experienced users. Thereby, input data is collected primarily from the experienced users, and input data from novice users is removed (filtered out). As another example, a controlled experiment may be set up to obtain meaningful input data for training (self-supervised learning). In the controlled experiment, users are requested to perform various actions for a certain goal and their click-through streams are recorded. The users may need to repeat it several times, looking for alternative ways to reach the goal. Overtime, users make fewer mistakes and provide meaningful input data indicative of user behavior i.e., control event sequences. The input data for the self-supervised learning is then augmented with these control sequences. As another example, action-intention modeling may be performed by predefining certain actionable tasks and actions therein to shrink the training window size and denoise the input data by focusing on a subset of data.

In one or more example embodiments, the network domain SSL service 120 generates new events. Specifically, for newly added events (i.e., cold start), the event embedding may be initialized with input from a domain expert. A domain expert (or the network domain SSL service 120) determines the closest event to a newly added event and initializes new event embedding structure with an event embedding structure of the closest event. As another example, a random initialization may be used. As more and more event sequences include the new event in a dataset (input data), contextual meaning of this new event is learned; hence, the new event embedding structure is adjusted accordingly by performing self-supervised machine learning.

By understanding user behavior, user intent and/or the network domain, the network domain SSL service 120 generates specific, useful, targeted actionable tasks that relate to user targeted issues (user's intent) and are specific to the network elements (network devices, sites) in the network domain to which they apply. The network domain SSL service 120 determines similar events and/or similar event sequences from multiple event sequences and generates a more efficient or faster event sequence. If the event includes “opening a service request” or “checking the security status of devices with certain condition”, then the network domain SSL service 120 may generate alternatives and/or faster event sequence(s) so that the users achieve the same goal more efficiently. Also, if the network domain SSL service 120 identifies a particular repeated event sequence for a user, the network domain SSL service 120 provides this particular event sequence to users at a time similar activities are about to be performed based on either the regularity of their activities (e.g., user performs a particular activity periodically) or the first few detected events in the event sequence e.g., user interactions involve events a, b, and c, then provide the probable next action (event d) that the user may need to perform next.

With continued reference to FIGS. 1-15B, FIGS. 16-19 are views illustrating user interfaces of the cloud portal 100 that provide actionable tasks for performing one or more actions associated with the network domain, according to example embodiments. The actionable tasks are generated based on self-supervised machine learning of the input data. The actionable tasks involve actions to be performed in the cloud portal 100. The actionable tasks are generated by the network domain SSL service 120, and more specifically, by the task engine 250 of FIG. 2.

The cloud portal 100 is an example of a network management and configuration platform that provides information about enterprise networks such as assets (network/computing equipment and software 102(1)-102(N), enterprise sites 110(1)-110(N) and support coverage, warranties, etc.), asset utilization, security advisories, open cases (for performance and troubleshooting). By interacting with the cloud portal 100, users may view network related information and configure or change the configuration of a network (e.g., assets, software, etc.). With vast capabilities of the cloud portal 100, it may be difficult for users to focus and/or prioritize their intended tasks. Users may be distracted with other components of the cloud portal 100. Also, users may find it difficult to perform their intended tasks in the cloud portal 100.

Accordingly, the task engine 250 generates actionable tasks to help the user perform their intended tasks. The tasks may include one or more shortcuts for executing one or more actions of a target task or a shortcut to the target task itself. The tasks may further include in-time support for executing user-intended task or actions in the task. The tasks may include fastest path for performing the task or a certain action in the task. The tasks may further include guided support (action by action support) for performing the intended task. Additionally, some of the actions may be performed by the cloud portal 100 and/or the network domain SSL service 120 based on understanding user's intention. As such, users are provided with personalized experience that is targeted to their needs/roles/tasks.

While example embodiments provided below relate to the cloud portal 100, the disclosure is not limited thereto. Actionable tasks may relate to a particular network device in the network domain, another network management system, a network controller, etc.

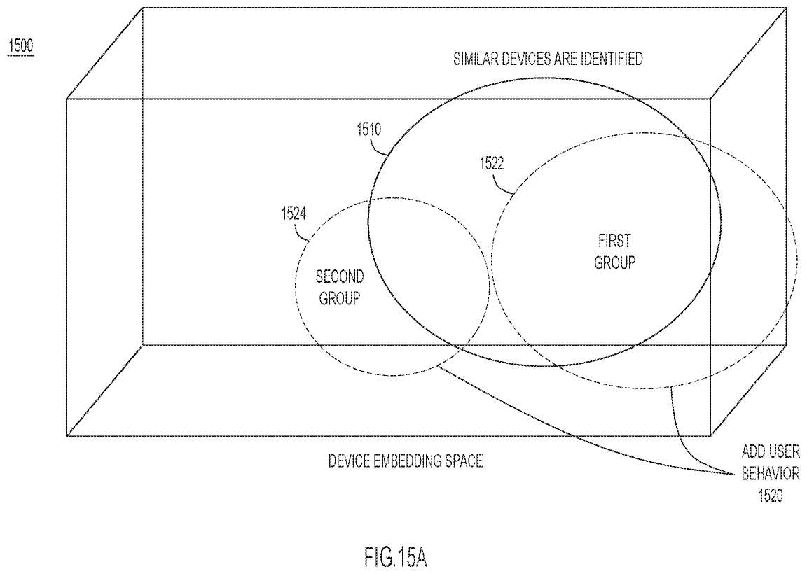

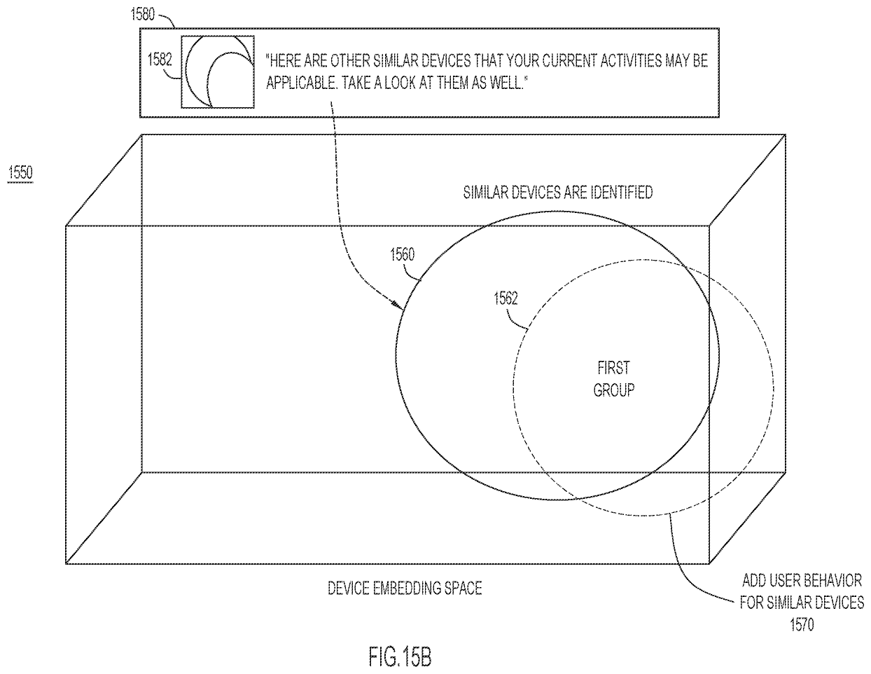

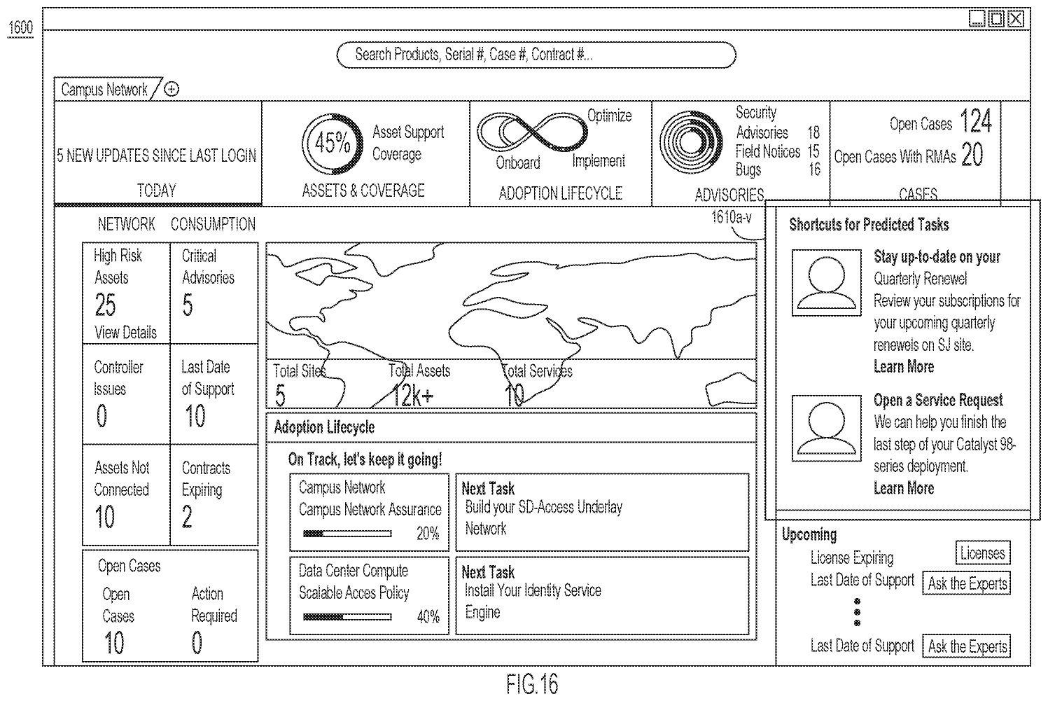

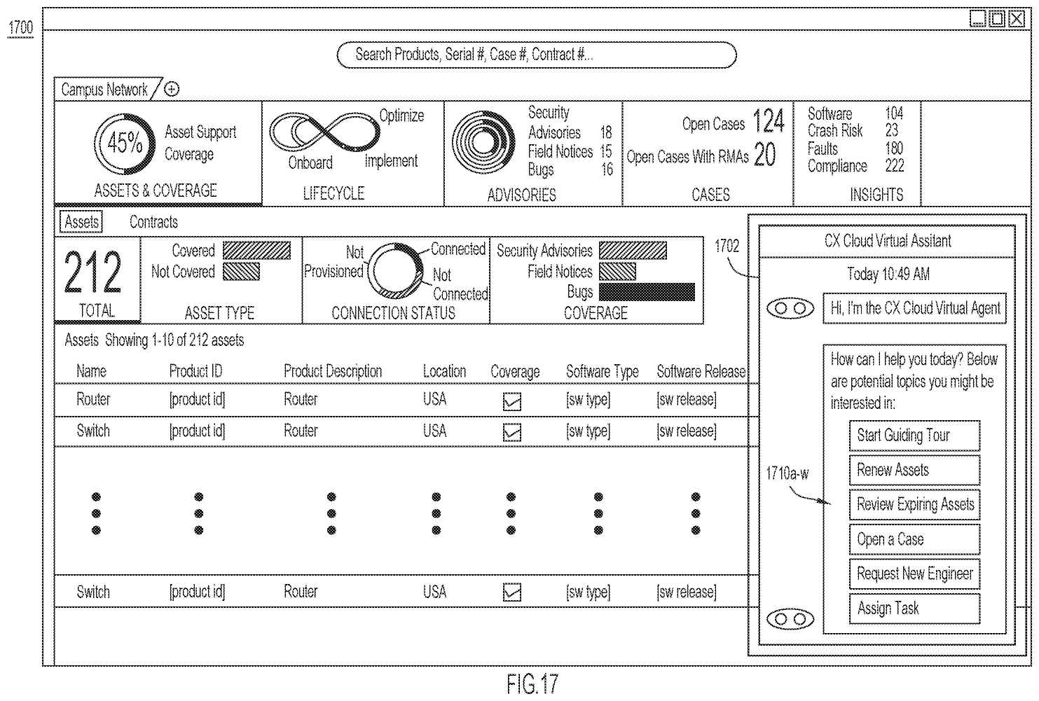

FIG. 16 is a view illustrating a user interface 1600 of the cloud portal 100 that provides a shortcut for executing one or more actions related to a configuration or management of the network domain, generated based on contextual meaning of the input data, according to an example embodiment.

The user interface 1600 is an example of a dashboard that summarizes main areas of the cloud portal 100 indicating advisories and/or alerts that require user's attention and serves as a gateway to various other areas of the cloud portal 100 (asset management, configuration changes, license renewals, etc.). By adding a plurality of shortcuts 1610a-v for predicted tasks to be performed, a personalized view of relevant actions is provided.

Specifically, the task engine 250 generates the plurality of shortcuts 1610a-v based on the contextual meaning of the input data (user behavior and/or network information) obtained from the event SSL engine 220 and/or the device SSL engine 240. The plurality of shortcuts 1610a-v reduce the number of operations required to perform a specific action by predicting the intended task for a particular user. Also, a shortcut may be a direct link to an area (page) where the required action can be performed. Users thus avoid multiple actions (e.g., clicks) to perform routine or intended tasks.

For example, by learning the contextual meaning of user behavior (e.g., user interactions in the cloud portal 100), the task engine 250 generates a first shortcut to renew a software license for a set of network devices and a second shortcut for opening a service request e.g., to troubleshoot an issue in the network. By selecting the first shortcut, the user renews software licenses for a set of network devices and/or the network domain SSL service 120 in conjunction with the cloud portal 100 renews the software licenses for the set of network devices and then notify the user. The first shortcut skips asset management main page, a selection of the set of assets (network devices), etc. The first shortcut directly provides actions needed to complete the task (and/or performs at least some of these actions for the user).

By performing self-supervised learning of encoded input data indicative of network information and/or user interactions in different parts of the cloud portal 100, the user interface 1600 is leveraged to provide the plurality of shortcuts 1610a-v for performing actions related to configuration and management of the network domain. The plurality of shortcuts 1610a-v are generated and added to the user interface 1600 based on understanding user behavior and intent via self-supervised machine learning of an embedded input information.

FIG. 17 is a view illustrating a user interface 1700 of the cloud portal 100 in which virtual assistance provides in-time support for executing user-intended actionable tasks for configuring or managing the network domain, according to an example embodiment. The user interface 1700 includes virtual assistance 1702 such as a chat bot that is selected or activated by a user interacting with the cloud portal 100.

The task engine 250 generates actionable tasks related to the network domain specifically for the virtual assistance 1702. The actionable tasks include a plurality of in-time support actions 1710a-w for predicting user-intended tasks based on self-supervised machine learning. The virtual assistance 1702 provides a list of suggestions with potential tasks that may be of interest to the users based on machine learning predictions. For example, the plurality of in-time support actions 1710a-w may include renew assets, review expiring assets, etc.

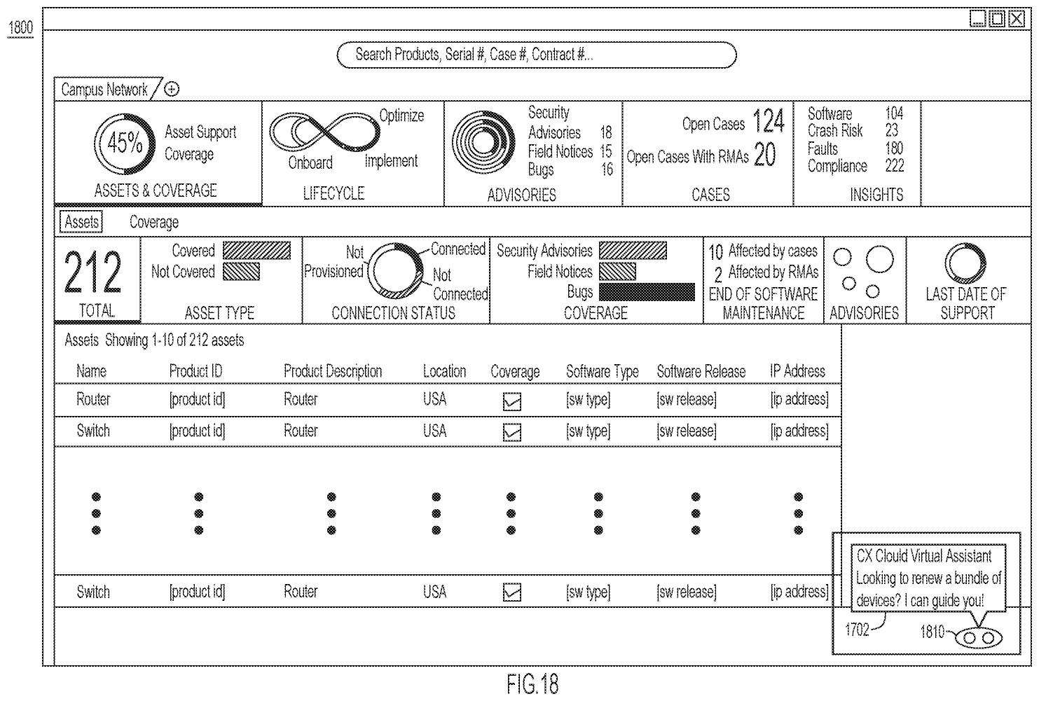

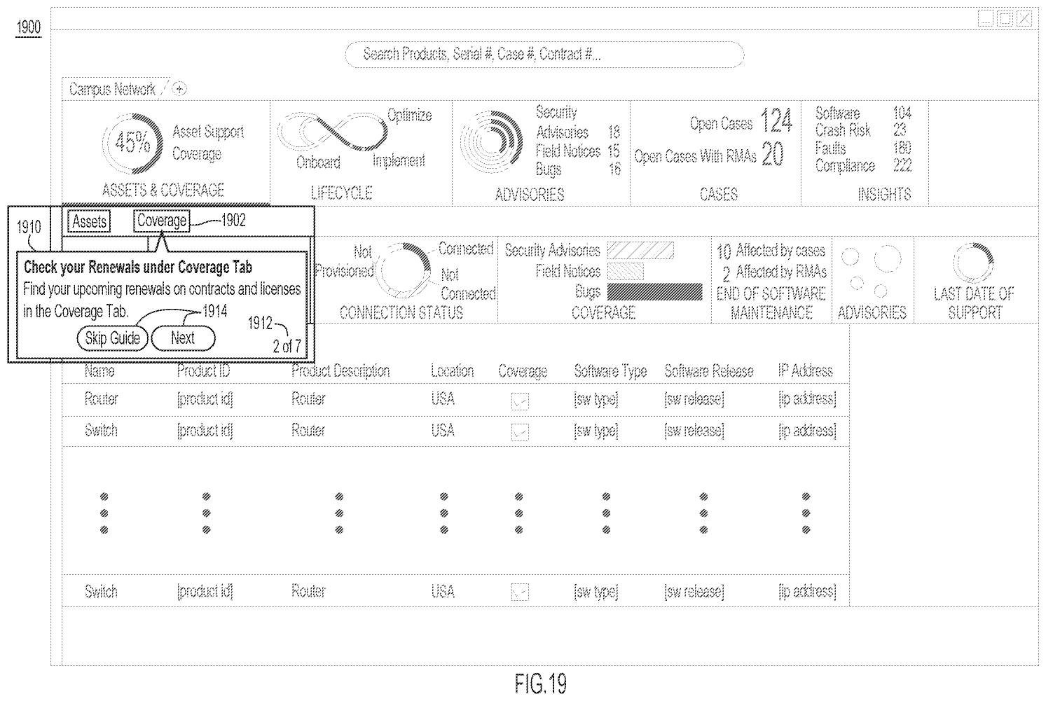

FIG. 18 is a view illustrating a user interface 1800 of the cloud portal 100 in which virtual assistance provides an efficient path for performing at least one actionable task, according to an example embodiment.

Users in the cloud portal 100 may require guidance to optimize their click-through stream (event sequence) for performing an actionable task. It is desirable for the users to avoid noise actions such as clicking on a wrong tab in the user interface 1700, hovering over unrelated items in the user interface 1700, etc. To optimize performance of an actionable task, the task engine 250 generates a guiding tour 1810 for the virtual assistance 1702. The guiding tour 1810 includes guided support that allows the user to follow the most efficient path (faster than another path) for performing the intended task. The efficient path includes various actions but is faster than another path for performing the same task.

In one example embodiment, the virtual assistance 1702 may further optimize performance of the actionable task by having the cloud portal 100 itself perform at least some of the actions in the task.

The virtual assistance 1702 may further provide a predicted next action/event in the faster path for performing the task. The virtual assistance 1702 thus guides the user (event by event) to perform the actionable task efficiently (fastest event sequence) i.e., faster than another path. The generated path has less actions and/or simpler actions than another path for performing the same task. The efficient path excludes noise actions.

By performing self-supervised learning of encoded input data indicative of network information and/or user interactions with the cloud portal 100, the user interface 1800 is leveraged to enable the virtual assistance 1702 to navigate the user through the faster path for performing the intended task. The virtual assistance 1702 may further highlight or emphasize next event/action needed for performing the task quickly and efficiently.

FIG. 19 is a view illustrating a user interface 1900 of the cloud portal 100 that provides guided support for performing at least one actionable task, according to an example embodiment.

The user interface 1900 includes a guided support 1910 for performing the intended task by sequentially providing or executing the next action in the task. For example, the guided support 1910 may highlight a particular area 1902 of the user interface 1900 for which the guided support 1910 is generated by the task engine 250. Additionally, the number of actions in the guided support may be indicated, shown at 1912. Further, navigation 1914 between sequential actions in the guided support 1910 are provided. The guided support 1910 provides a first path for performing the task that is faster than a second path for performing this task. The guided support 1910 optimizes user's event sequence(s) i.e., click-through stream, for performing the task. Moreover, additional journeys may be highlighted at any time based on self-supervised machine learning of embedded input data. For example, the most efficient or faster path for user's potential goals is highlighted via the guided support 1910.

For example, by performing self-supervised machine learning, the network domain SSL service 120 determines that at the end of every quarter, user A renews a set of network devices at an enterprise site B. The network domain SSL service 120 determines that user's intent is to renew coverage and that the task relates to a set of network devices at the enterprise site B. Accordingly, at the end of the next quarter, the network domain SSL service 120 generates an actionable task that includes a popup message from the virtual assistance 1702 suggesting guidance with renewing a bundle of devices (the set of network devices) such as in FIG. 18. If the user selects to renew, the user is then guided such as in FIG. 19 such that an efficient or faster path for renewing this set of network devices is provided. The users then optimize their journey.

The techniques provided herein encode user behavior (user interactions) into an event embedding structure. The techniques provided herein further encode network information (devices and sites), which essentially encodes the nodes (devices), edges (connections between device), and (sub)graphs (network or sub-network). By performing self-supervised machine learning of the embedded structure, user's intentions and goal may be determined. Further, device characteristics, functions, and usage are understood. For example, similar embeddings for devices (i.e., their role, device type, product family, etc., are similar), regardless of the site/network/enterprise they are in, function similarly and are used in a particular intended way. On the other hand, if similar devices form multiple groups or show statistically significant differences in an embedding space, using self-supervised machine learning differences are analyzed to determine whether some networks/enterprise site use similar devices in their own unique way, for different purposes, different by industry, geolocation, enabled/disabled feature(s), a combination of criteria, etc. The techniques proactively identify abnormal or deviant device usages in an enterprise site, notifies the users of these deviations, and aide in remedying these deviations if desired by users. The techniques determine sharable attributes between elements of embedded user behavior and/or embedded network domain, to provide actionable tasks such as how the user-device interactions appear. For example, similar activities of users for the similar devices, whether there are multiple ways of interacting with the devices among the users, etc.

The techniques presented above obtain contextual, semantic meaning of events and event sequences from click-through stream data by leveraging self-supervised machine learning. The self-supervised machine learning involves MEM and ASP to understand users' behavior and intent. The techniques presented above further obtain contextual, semantic meaning of the network domain including devices, network sites, and/or connections by leveraging similar self-supervised learning. The self-supervised learning involves MDM and ASP used in solo or in conjunction with the event understanding. By leveraging both events and network devices understanding, a deeper understanding of network-specific users' behavior and intentions are obtained. Based on understanding network-specific users' behavior and intentions, useful and actionable downstream tasks are generated such as in-time and guided support, next task prediction, and auto-generated shortcuts. The actionable tasks may be generated based on both how users behave within the network domain and/or how users interact with their network devices.

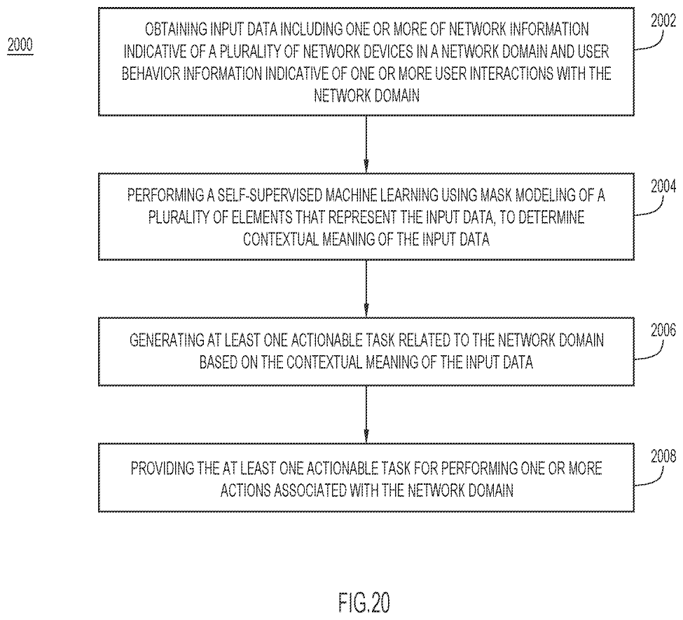

FIG. 20 is a flowchart illustrating a method 2000 of providing at least one actionable task for performing one or more actions associated with the network domain based on self-supervised machine learning, according to an example embodiment. The method 2000 may be performed by a computing device such as a server or a group of servers that execute the network domain SSL service 120 of FIGS. 1-19.

The method 2000 involves, at 2002, a computing device obtaining input data including one or more of network information indicative of a plurality of network devices in a network domain and user behavior information indicative of one or more user interactions with the network domain.

The method 2000 further involves at 2004, the computing device performing a self-supervised machine learning using mask modeling of a plurality of elements that represent the input data, to determine contextual meaning of the input data.

Additionally, the method 2000 involves at 2006, the computing device generating at least one actionable task related to the network domain based on the contextual meaning of the input data.

The method 2000 further involves at 2008, the computing device providing the at least one actionable task for performing one or more actions associated with the network domain.

In one form, the operation 2008 of providing the at least one actionable task for performing the one or more actions may include providing at least one shortcut for executing the one or more actions that relate to a configuration or management of the network domain. The operation 2008 of providing the at least one actionable task for performing the one or more actions may, alternatively or in addition, include providing guided support for performing the at least one actionable task by sequentially providing or executing a next action from the one or more actions and/or providing a first path for performing the at least one actionable task. The first path includes the one or more actions and is faster than a second path for performing the at least one actionable task.

According to one or more example embodiments, the input data may include the network information and the user behavior information. The method 2000 may further involve determining device similarities of the plurality of network devices and behavioral similarities between the one or more user interactions, based on the contextual meaning of the input data. The operation 2006 of generating the at least one actionable task may include generating at least one of a first action related to at least one network device in the network domain that is similar to one of the plurality of network devices based on the device similarities, a second action related to a user behavior that is similar to a behavior defined by the one or more user interactions based on the behavioral similarities, and/or a third action to be performed on the at least one network device that is related to the user behavior, based on the device similarities and the behavioral similarities.

In one instance, the input data may include the user behavior information in a form of click-through stream data. The method 2000 may further include embedding one or more event sequences in the click-through stream data to generate an event embedding structure that includes the contextual meaning of a respective event, a sequence of the respective event, and a position of the respective event in the sequence. The operation 2004 of performing the self-supervised machine learning may include the mask modeling of the event embedding structure.

According to one or more example embodiments, embedding the one or more event sequences may include generating grouping information for the click-through stream data by grouping the one or more event sequences into one or more groups based on at least one attribute that includes one or more of an identity of a user that generated the respective event, a role of the user within the network domain, an enterprise of the user, and a geolocation of the user and embedding the grouping information into the event embedding structure.

According to one or more example embodiments, generating the grouping information may include determining the at least one attribute of the click-through stream data based on clustering the one or more event sequences in the event embedding structure.

In one form, the operation 2004 of performing the self-supervised machine learning may include iteratively training the event embedding structure by replacing an element in the event embedding structure with a masked token to determine the contextual meaning of a user behavior defined by the one or more user interactions.

In yet another form, the operation 2004 of performing the self-supervised machine learning may further include iteratively training the event embedding structure using an adjacent sequence prediction to determine one or more relationships between the one or more user interactions.

In another instance, the input data may include the network information. The method 2000 may further include embedding the network information indicative of the plurality of network devices to generate a network embedding structure that includes the contextual meaning of a respective network device, an enterprise site of the respective network device, and a connection of the respective network device to other network devices in the network domain. The operation 2004 of performing the self-supervised machine learning may involve the mask modeling of the network embedding structure.

According to one or more example embodiments, the network embedding structure may include topology of the network domain defined by embedding the connection of the respective network device for each of the plurality of network devices using an adjacency matrix.

In one form, the operation 2004 of performing the self-supervised machine learning may include iteratively training the network embedding structure by replacing one of the plurality of network devices in the network embedding structure with a masked token to determine the contextual meaning of the plurality of network devices including one or more of a device type, a device role in the network domain, a device function, or a device product family type.

In yet another form, the operation 2004 of performing the self-supervised machine learning may further include iteratively training the network embedding structure using an adjacent sequence prediction to determine one or more relationships between a plurality of enterprise sites in the network domain.

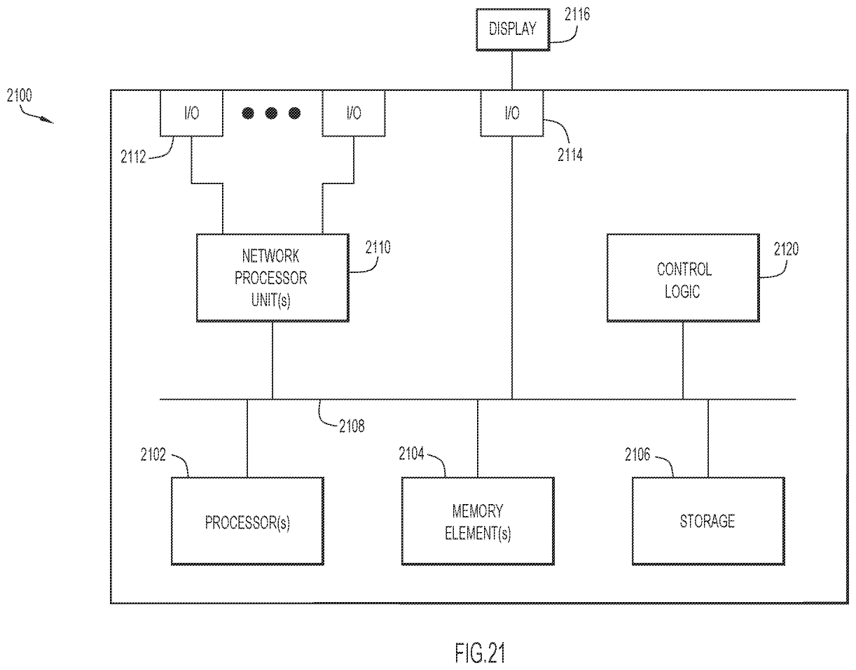

FIG. 21 is a hardware block diagram of a computing device 2100 that may perform functions associated with any combination of operations in connection with the techniques depicted in FIGS. 1-20, according to various example embodiments, including, but not limited to, operations of the computing device or one or more servers that execute the cloud portal 100 and/or the network domain SSL service 120. Further, the computing device 2100 may be representative of one of the network devices, network/computing equipment, or hardware asset of an enterprise. It should be appreciated that FIG. 21 provides only an illustration of one example embodiment and does not imply any limitations with respect to the environments in which different example embodiments may be implemented. Many modifications to the depicted environment may be made.

In at least one embodiment, computing device 2100 may include one or more processor(s) 2102, one or more memory element(s) 2104, storage 2106, a bus 2108, one or more network processor unit(s) 2110 interconnected with one or more network input/output (I/O) interface(s) 2112, one or more I/O interface(s) 2114, and control logic 2120. In various embodiments, instructions associated with logic for computing device 2100 can overlap in any manner and are not limited to the specific allocation of instructions and/or operations described herein.

In at least one embodiment, processor(s) 2102 is/are at least one hardware processor configured to execute various tasks, operations and/or functions for computing device 2100 as described herein according to software and/or instructions configured for computing device 2100. Processor(s) 2102 (e.g., a hardware processor) can execute any type of instructions associated with data to achieve the operations detailed herein. In one example, processor(s) 2102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 2104 and/or storage 2106 is/are configured to store data, information, software, and/or instructions associated with computing device 2100, and/or logic configured for memory element(s) 2104 and/or storage 2106. For example, any logic described herein (e.g., control logic 2120) can, in various embodiments, be stored for computing device 2100 using any combination of memory element(s) 2104 and/or storage 2106. Note that in some embodiments, storage 2106 can be consolidated with one or more memory elements 2104 (or vice versa), or can overlap/exist in any other suitable manner.

In at least one embodiment, bus 2108 can be configured as an interface that enables one or more elements of computing device 2100 to communicate in order to exchange information and/or data. Bus 2108 can be implemented with any architecture designed for passing control, data and/or information between processors, memory elements/storage, peripheral devices, and/or any other hardware and/or software components that may be configured for computing device 2100. In at least one embodiment, bus 2108 may be implemented as a fast kernel-hosted interconnect, potentially using shared memory between processes (e.g., logic), which can enable efficient communication paths between the processes.

In various embodiments, network processor unit(s) 2110 may enable communication between computing device 2100 and other systems, entities, etc., via network I/O interface(s) 2112 to facilitate operations discussed for various embodiments described herein. In various embodiments, network processor unit(s) 2110 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 2100 and other systems, entities, etc. to facilitate operations for various embodiments described herein. In various embodiments, network I/O interface(s) 2112 can be configured as one or more Ethernet port(s), Fibre Channel ports, and/or any other I/O port(s) now known or hereafter developed. Thus, the network processor unit(s) 2110 and/or network I/O interface(s) 2112 may include suitable interfaces for receiving, transmitting, and/or otherwise communicating data and/or information in a network environment.

I/O interface(s) 2114 allow for input and output of data and/or information with other entities that may be connected to computing device 2100. For example, I/O interface(s) 2114 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 2116, a display screen, or the like.

In various embodiments, control logic 2120 can include instructions that, when executed, cause processor(s) 2102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications, and a processor. The processor is configured to perform operations including obtaining input data including one or more of network information indicative of a plurality of network devices in a network domain and user behavior information indicative of one or more user interactions with the network domain. The operations further include performing a self-supervised machine learning using mask modeling of a plurality of elements that represent the input data, to determine contextual meaning of the input data and generating at least one actionable task related to the network domain based on the contextual meaning of the input data. The operations further include providing the at least one actionable task for performing one or more actions associated with the network domain.

In yet another example embodiment, one or more non-transitory computer readable storage media encoded with instructions are provided. When the media is executed by a processor, the instructions cause the processor to execute a method that includes obtaining input data including one or more of network information indicative of a plurality of network devices in a network domain and user behavior information indicative of one or more user interactions with the network domain. The method further includes performing a self-supervised machine learning using mask modeling of a plurality of elements that represent the input data, to determine contextual meaning of the input data and generating at least one actionable task related to the network domain based on the contextual meaning of the input data. The method further includes providing the at least one actionable task for performing one or more actions associated with the network domain.

In yet another example embodiment, a system is provided that includes the devices and operations explained above with reference to FIGS. 1-21.

The programs described herein (e.g., control logic 2120) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 2106 and/or memory elements(s) 2104 can store data, software, code, instructions (e.g., processor instructions), logic, parameters, combinations thereof, and/or the like used for operations described herein. This includes the storage 2106 and/or memory elements(s) 2104 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IOT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a computing device, input data including one or more of network information indicative of a plurality of network devices in a network domain and user behavior information indicative of one or more user interactions with the network domain;
performing, by the computing device, a self-supervised machine learning using mask modeling of a plurality of elements that represent the input data, to determine contextual meaning of the input data;
generating at least one actionable task related to the network domain based on the contextual meaning of the input data; and
providing, by the computing device, the at least one actionable task for performing one or more actions associated with the network domain.

2. The method of claim 1, wherein providing the at least one actionable task for performing the one or more actions includes one or more of:
providing at least one shortcut for executing the one or more actions that relate to a configuration or management of the network domain;
providing guided support for performing the at least one actionable task by sequentially providing or executing a next action from the one or more actions; or
providing a first path for performing the at least one actionable task, the first path includes the one or more actions and is faster than a second path for performing the at least one actionable task.

3. The method of claim 1, wherein the input data includes the network information and the user behavior information and further comprising:
determining device similarities of the plurality of network devices and behavioral similarities between the one or more user interactions, based on the contextual meaning of the input data,
wherein generating the at least one actionable task includes generating at least one of:
a first action related to at least one network device in the network domain that is similar to one of the plurality of network devices based on the device similarities,
a second action related to a user behavior that is similar to a behavior defined by the one or more user interactions based on the behavioral similarities, or
a third action to be performed on the at least one network device that is related to the user behavior, based on the device similarities and the behavioral similarities.

4. The method of claim 1, wherein the input data includes the user behavior information in a form of click-through stream data and further comprising:
embedding one or more event sequences in the click-through stream data to generate an event embedding structure that includes the contextual meaning of a respective event, a sequence of the respective event, and a position of the respective event in the sequence,
wherein performing the self-supervised machine learning includes the mask modeling of the event embedding structure.

5. The method of claim 4, wherein embedding the one or more event sequences further comprises:
generating grouping information for the click-through stream data by grouping the one or more event sequences into one or more groups based on at least one attribute that includes one or more of an identity of a user that generated the respective event, a role of the user within the network domain, an enterprise of the user, and a geolocation of the user; and
embedding the grouping information into the event embedding structure.

6. The method of claim 5, wherein generating the grouping information includes:
determining the at least one attribute of the click-through stream data based on clustering the one or more event sequences in the event embedding structure.

7. The method of claim 4, wherein performing the self-supervised machine learning includes:
iteratively training the event embedding structure by replacing an element in the event embedding structure with a masked token to determine the contextual meaning of a user behavior defined by the one or more user interactions.

8. The method of claim 7, wherein performing the self-supervised machine learning further includes:
iteratively training the event embedding structure using an adjacent sequence prediction to determine one or more relationships between the one or more user interactions.

9. The method of claim 1, wherein the input data includes the network information and further comprising:
embedding the network information indicative of the plurality of network devices to generate a network embedding structure that includes the contextual meaning of a respective network device, an enterprise site of the respective network device, and a connection of the respective network device to other network devices in the network domain,
wherein performing the self-supervised machine learning includes the mask modeling of the network embedding structure.

10. The method of claim 9, wherein the network embedding structure includes topology of the network domain defined by embedding the connection of the respective network device for each of the plurality of network devices using an adjacency matrix.

11. The method of claim 9, wherein performing the self-supervised machine learning includes:
iteratively training the network embedding structure by replacing one of the plurality of network devices in the network embedding structure with a masked token to determine the contextual meaning of the plurality of network devices including one or more of a device type, a device role in the network domain, a device function, or a device product family type.

12. The method of claim 11, wherein performing the self-supervised machine learning further includes:
iteratively training the network embedding structure using an adjacent sequence prediction to determine one or more relationships between a plurality of enterprise sites in the network domain.

13. An apparatus comprising:
a memory;
a network interface configured to enable network communications; and
a processor, wherein the processor is configured to perform a method comprising:
obtaining input data including one or more of network information indicative of a plurality of network devices in a network domain and user behavior information indicative of one or more user interactions with the network domain;
performing a self-supervised machine learning using mask modeling of a plurality of elements that represent the input data, to determine contextual meaning of the input data;
generating at least one actionable task related to the network domain based on the contextual meaning of the input data; and
providing the at least one actionable task for performing one or more actions associated with the network domain.

14. The apparatus of claim 13, wherein the processor is configured to provide the at least one actionable task for performing the one or more actions by providing one or more of:
at least one shortcut for executing the one or more actions that relate to a configuration or management of the network domain;
guided support for performing the at least one actionable task by sequentially providing or executing a next action from the one or more actions; or
a first path for performing the at least one actionable task, the first path includes the one or more actions and is faster than a second path for performing the at least one actionable task.

15. The apparatus of claim 13, wherein the input data includes the network information and the user behavior information and the processor is further configured to perform:
determining device similarities of the plurality of network devices and behavioral similarities between the one or more user interactions, based on the contextual meaning of the input data,
wherein the processor is configured to generate the at least one actionable task by generating at least one of:
a first action related to at least one network device in the network domain that is similar to one of the plurality of network devices based on the device similarities,
a second action related to a user behavior that is similar to a behavior defined by the one or more user interactions based on the behavioral similarities, or
a third action to be performed on the at least one network device that is related to the user behavior, based on the device similarities and the behavioral similarities.

16. The apparatus of claim 13, wherein the input data includes the user behavior information in a form of click-through stream data and the processor is further configured to perform:
embedding one or more event sequences in the click-through stream data to generate an event embedding structure that includes the contextual meaning of a respective event, a sequence of the respective event, and a position of the respective event in the sequence,
wherein the processor performs the self-supervised machine learning by the mask modeling of the event embedding structure.

17. The apparatus of claim 13, wherein the input data includes the network information and the processor is further configured to perform:
embedding the network information indicative of the plurality of network devices to generate a network embedding structure that includes the contextual meaning of a respective network device, an enterprise site of the respective network device, and a connection of the respective network device to other network devices in the network domain,
wherein the processor performs the self-supervised machine learning by the mask modeling of the network embedding structure.

18. One or more non-transitory computer readable storage media encoded with software comprising computer executable instructions that, when executed by a processor, cause the processor to perform a method including:
obtaining input data including one or more of network information indicative of a plurality of network devices in a network domain and user behavior information indicative of one or more user interactions with the network domain;
performing a self-supervised machine learning using mask modeling of a plurality of elements that represent the input data, to determine contextual meaning of the input data;
generating at least one actionable task related to the network domain based on the contextual meaning of the input data; and
providing the at least one actionable task for performing one or more actions associated with the network domain.

19. The one or more non-transitory computer readable storage media according to claim 18, wherein the computer executable instructions cause the processor to provide the at least one actionable task for performing the one or more actions by providing one or more of:
at least one shortcut for executing the one or more actions that relate to a configuration or management of the network domain;
guided support for performing the at least one actionable task by sequentially providing or executing a next action from the one or more actions; or
a first path for performing the at least one actionable task, the first path includes the one or more actions and is faster than a second path for performing the at least one actionable task.

20. The one or more non-transitory computer readable storage media according to claim 18, wherein the input data includes the network information and the user behavior information and the computer executable instructions cause the processor to further perform:
determining device similarities of the plurality of network devices and behavioral similarities between the one or more user interactions, based on the contextual meaning of the input data,
wherein the processor generates the at least one actionable task by generating at least one of:
a first action related to at least one network device in the network domain that is similar to one of the plurality of network devices based on the device similarities,
a second action related to a user behavior that is similar to a behavior defined by the one or more user interactions based on the behavioral similarities, or
a third action to be performed on the at least one network device that is related to the user behavior, based on the device similarities and the behavioral similarities.

21. The one or more non-transitory computer readable storage media according to claim 18, wherein the input data includes the user behavior information in a form of click-through stream data and the computer executable instructions cause the processor to further perform:
embedding one or more event sequences in the click-through stream data to generate an event embedding structure that includes the contextual meaning of a respective event, a sequence of the respective event, and a position of the respective event in the sequence,
wherein the processor performs the self-supervised machine learning by the mask modeling of the event embedding structure.
